(19) United States
(12) Patent Application Publication
(10) Pub. No.: US 2025/0371657 A1
(43) Pub. Date: Dec. 4, 2025

(54) SUPER-RESOLUTION IMAGE DISPLAY AND FREE SPACE COMMUNICATION USING DIFFRACTIVE DECODERS

(71) Applicant: THE REGENTS OF THE UNIVERSITY OF CALIFORNIA, Oakland, CA (US)

(72) Inventors: Aydogan Ozcan, Los Angeles, CA (US); Cagatay Isil, Los Angeles, CA (US); Deniz Mengu, Los Angeles, CA (US); Md Sadman Sakib Rahman, Los Angeles, CA (US)

(73) Assignee: THE REGENTS OF THE UNIVERSITY OF CALIFORNIA, Oakland, CA (US)

(21) Appl. No.: 18/873,741

(22) PCT Filed: Jun. 9, 2023
(86) PCT No.: PCT/US2023/068256

§ 371 Date: Dec. 11, 2024

Related U.S. Application Data
(60) Provisional application No. 63/352,045, filed on Jun. 14, 2022.
(60) Provisional application No. 63/497,052, filed on Apr. 19, 2023.

(51) Int. Cl. G06T 3/4046; G06T 3/4053; H04N 7/22

(52) U.S. Cl. CPC G06T 3/4046; G06T 3/4053; H04N 7/22

(57) ABSTRACT

A deep learning-enabled system for the display or projection of high-resolution images is disclosed that is based on a jointly-trained pair of an electronic encoder network and an all-optical decoder network to synthesize/project super-resolved images using low-resolution wavefront modulators. The electronic encoder network rapidly pre-processes the high-resolution images of interest so that their spatial information is encoded into low-resolution (LR) modulation patterns, projected via a low SBP wavefront modulator. The all-optical decoder network processes this LR encoded information using thin transmissive layers that are structured using deep learning to all-optically synthesize and project super-resolved images at its output FOV. Results indicate that this diffractive image display system can achieve a super-resolution factor of ˜4, demonstrating a ˜16-fold increase in SBP. The system can be scaled to operate at visible wavelengths and be used for large FOV and high-resolution displays that are compact, low-power, and computationally efficient.

### RELATED APPLICATIONS

This application claims priority to U.S. Provisional Patent Application No. 63/352,045 filed on Jun. 14, 2022 and U.S. Provisional Patent Application No. 63/497,052 filed on Apr. 19, 2023, which are hereby incorporated by reference. Priority is claimed pursuant to 35 U.S.C. § 119 and any other applicable statute.

### STATEMENT REGARDING FEDERALLY SPONSORED RESEARCH AND DEVELOPMENT

This invention was made with government support under DE-SC0023088 awarded by the U.S. Department of Energy. The government has certain rights in the invention.

### TECHNICAL FIELD

The technical field relates to a diffractive super-resolution display. The display design uses a deep-learning enabled diffractive display design that is based on a jointly-trained pair of an electronic encoder and a diffractive optical decoder to synthesize/project super-resolved images using low-resolution wavefront modulators. The technical field also relates to free-space optical communications systems and methods that communicate information despite the presence of occlusion(s) blocking the light path.

### BACKGROUND

In the past decade, augmented/virtual reality (AR/VR) systems have attracted tremendous interest aiming to provide immersive and enhanced user experiences in a vast range of areas, including, e.g., human-computer interactions, visual media, art, and entertainment consumption as well as biomedical applications and instrumentation. However, the realizations of AR/VR systems have mostly relied on fixed focus stereoscopic display architectures that offer partially limited performance in terms of power efficiency, device form factor, and support of natural depth cues of the human visual system. Holographic displays that use spatial light modulators (SLMs) and coherent illumination with, e.g., lasers, constitute a promising alternative that allows precise control and manipulation of the optical wavefront enabling simplifications in the optical setup between the SLM and the human eye. Furthermore, this approach can emulate the wavefront emanating from a desired 3D scene to provide the depth cues of human visual perception, potentially eliminating the sources of user discomfort associated with the fixed focus stereoscopic displays e.g., vergence-accommodation conflict.

Despite these advantages, holographic displays have in general relatively modest space-bandwidth products (SBP) due to the limitations of the current wavefront modulator technology, which is directly dictated by the number of individually addressable pixels on the SLM. As a result, the current holographic display systems fail to fulfill the spatiotemporal requirements of AR/VR devices due to the limited size of the synthesized images and the extent of the corresponding viewing angles. In fact, earlier research on the subject showed that a wavefront modulator in a wearable AR/VR device must have ˜50K×50K pixels, ideally with a pixel pitch smaller than the wavelength of the visible light. Such an SLM is beyond the reach of current technology, considering that the state-of-the-art SLMs can offer resolutions up to 4K (e.g., 3,840 horizontal and 2,160 vertical pixels), with a pixel pitch that is typically 5-to-20-fold larger than the wavelength of the light in the visible part of the spectrum. Even if new SLM architectures were to be developed to meet such large SBPs, they would possibly present other challenges in terms of power consumption, memory usage, computational burden, form factor, and system complexity.

Over the years, considerable effort has been devoted to increasing the SBP of SLM technology to unleash the full potential of holographic displays, including various designs that use spatial-multiplexing of wavefront modulators arranged in application-specific configurations. While these multiplexed systems offer significantly larger SBPs compared to a single SLM, the utilization of multiple SLMs results in bulky optical architectures with tedious alignment and synchronization procedures in addition to increased power consumption, memory usage, and computational burden. Besides spatial-multiplexing, numerous time-multiplexing methods have also been developed for increasing the SBP of holographic displays, often relying on rotating mirrors and/or other moving optomechanical components, which complicate the optical setup. An alternative method of enhancing the SBP of holographic displays without any spatial- and/or time-multiplexing was presented by Yu et al., where the authors introduced a complex modulation medium, e.g., multiple random diffusers, into the path of the optical signals and exploited random speckle patterns generated due to multiple light scattering events by exciting only a handful of optical modes based on wavefront shaping. See H. Yu. K. Lee, J. Park, Y. Park, Ultrahigh-definition dynamic 3D holographic display by active control of volume speckle fields. Nature Photon. 11, 186-192 (2017). While this approach provides relatively large viewing angles, the attainable image quality is deteriorated due to the random nature of the diffusers, resulting in background noise and speckle. A similar approach was also developed for AR displays by introducing periodic gratings, instead of random diffusers, into the light path between the SLM and the lens, serving as an eyepiece. See X. Duan, J. Liu, X. Shi, Z. Zhang. J. Xiao, Full-color see-through near-eye holographic display with 80&#x00B0; field of view and an expanded eye-box. Opt. Express. OE. 28, 31316-31329 (2020).

Recently, advances in machine learning have been extended to bring deep learning-enabled solutions to some of the earlier discussed challenges associated with holographic displays. Various deep neural network architectures were used to learn the transformation from a given target image to the corresponding phase-only pattern over the SLM, aiming to replace the traditional iterative hologram computation algorithms with faster and better alternatives. Deep neural networks have also been utilized to parameterize the wave propagation models between the SLM modulation patterns and the synthesized images for calibrating the forward model to partially account for physical error sources and aberrations present in the optical set-up.

### SUMMARY

Here, in one embodiment, a deep learning-enabled diffractive super-resolution (SR) image display system is disclosed that is based on a pair of jointly-trained electronic encoder and all-optical decoder that projects super-resolved images at the output while maintaining the size of the image field-of-view (FOV), thereby surpassing the SBP restrictions enforced by the wavefront modulator or the SLM. This diffractive SR display also enables a significant reduction in the computational burden and data transmission/storage by encoding the high-resolution images (to be projected/displayed) into compact, low-resolution representations with lower number of pixels per image, where k>1 defines the SR factor that is targeted during training of the diffractive SR image display system. In this computational image display approach, the main functionality of the electronic encoder network (i.e., the front-end based on a convolutional neural network, CNN) is to compute the low-resolution (LR) SLM modulation patterns by digitally pre-processing the high-resolution images to encode LR representations of the input information. The all-optical decoder “back-end” of this SR display is implemented through a passive diffractive network that is trained jointly with the electronic encoder CNN to process the input waves generated by the SLM pattern, and project a super-resolved image by decoding the encoded LR representation of the input image. Stated differently, the all-optical diffractive decoder achieves super-resolved image projection at its output FOV by processing the coherent waves generated by the LR encoded representation of the input image, which is calculated by the jointly-trained encoder CNN. This diffractive decoder forms the all-optical back-end of the SR image display system, and it does not consume power except for the illumination light of the low-resolution SLM and computes the super-resolved image instantly, i.e., through the light propagation within a thin diffractive volume.

The SR capabilities of this unique diffractive display design are demonstrated using a lens-free image projection system as shown in FIGS. 1A, 1B, 6A, 6B. The diffractive SR display can achieve an SR factor of ˜4, i.e., a ˜16-fold increase in SBP, using a 5-layer diffractive decoder network. The success of this diffractive SR display framework was experimentally demonstrated based on 3D-fabricated diffractive decoders that operate at the THz part of the spectrum. This diffractive SR image display system can be scaled to work at any part of the electromagnetic spectrum, including the visible wavelengths, and can be used for image display solutions with enhanced SBP, forming the building blocks of next-generation 3D display technology including, e.g., head-mounted AR/VR devices.

In one embodiment, a system or device for the display or projection of high-resolution images includes at least one electronic encoder network that includes a trained deep neural network configured to receive one or more high-resolution images and generating low-resolution modulation patterns or images representative of the one or more high-resolution images using one of: a display, a projector, a screen, a spatial light modulator (SLM), or a wavefront modulator; and an all-optical decoder network including one or more optically transmissive and/or reflective substrate layers arranged in an optical path, each of the optically transmissive and/or reflective substrate layer(s) having a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive light resulting from the low resolution modulation patterns or images representative of the one or more high-resolution images and optically generate corresponding high-resolution image projections at an output field-of-view.

In another embodiment, a device for decoding high-resolution images from low-resolution modulation patterns or images representative of the one or more high-resolution images includes an all-optical decoder network comprising one or more optically transmissive and/or reflective substrate layers arranged in an optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive the low resolution modulation patterns or images representative of the one or more high-resolution images and optically generate corresponding high-resolution image projections at an output field-of-view.

In some embodiments, the all-optical decoder network is incorporated into a wearable device, goggles, or glasses. Thus, the electronic encoder network front-end of the system may be separate from the all-optical decoder network portion or back-end of the system or device. For example, patterns or images are created using the at least one electronic encoder network. A separate all-optical decoder network is then used to reconstruct the high-resolution image(s) that were encoded using the at least one electronic encoder network.

In another embodiment, a method of projecting high-resolution images over a field-of-view includes providing a system or device that includes at least one electronic encoder network having a trained deep neural network configured to receive one or more high-resolution images and generate low-resolution modulation patterns or images representative of the one or more high-resolution images using one or more of: a display, a projector, a screen, a spatial light modulator (SLM), or a wavefront modulator; and an all-optical decoder network including one or more optically transmissive and/or reflective substrate layers arranged in an optical path, each of the optically transmissive and/or reflective substrate layer(s) including a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive light resulting from the low resolution modulation patterns or images representative of the one or more high-resolution images and optically generate corresponding high-resolution image projections at an output field-of-view. The method involves inputting one or more high-resolution images to the electronic encoder network so as to generate the low-resolution modulation patterns or images representative of the one or more high-resolution images and optically generating the corresponding high-resolution image projections at the output field-of-view.

In another embodiment, a method of communicating information with one or more persons includes: transmitting low-resolution modulation patterns or images representative of one or more higher-resolution images containing the information using one or more of: a display, a projector, a screen, a spatial light modulator (SLM), or a wavefront modulator; and all-optically decoding the low-resolution modulation patterns or images with one or more optically transmissive and/or reflective substrate layers arranged in an optical path, each of the optically transmissive and/or reflective substrate layer(s) having a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive light resulting from the low resolution modulation patterns or images representative of the one or more high-resolution images and generate corresponding high-resolution image projections containing the information at an output field-of-view.

In another embodiment, a communication system for transmitting a message or signal in space includes at least one electronic encoder network and an all-optical decoder network. The at least one electronic encoder network includes a trained deep neural network configured to receive a message or signal and generate a phase-encoded and/or amplitude-encoded optical representation of the message or signal that is transmitted along an optical path. The all-optical decoder network includes one or more optically transmissive and/or reflective substrate layers arranged in the optical path with the encoder network that at least partially occluded and/or blocked with an opaque occlusion and/or a diffusive medium, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive secondary optical waves scattered by the opaque occlusion and/or diffusive medium and optically generate the message or signal at an output field-of-view.

In another embodiment, a device for decoding an encoded optical message or signal includes an all-optical decoder network comprising one or more optically transmissive and/or reflective substrate layers arranged in an optical path of the encoded optical message or signal that at least partially occluded and/or blocked with an opaque occlusion and/or a diffusive medium, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive secondary optical waves scattered by the opaque occlusion and/or diffusive medium and optically generate the message or signal at an output field-of-view.

In another embodiment, a method is disclosed of transmitting a message or signal over space in the presence of an obstructing opaque occlusion and/or a diffusive medium. The method includes providing a system including at least one electronic encoder network and an all-optical decoder network. The at least one electronic encoder network includes a trained deep neural network configured to receive a message or signal and generate a phase-encoded and/or amplitude-encoded optical representation of the message or signal that is transmitted along an optical path. The all-optical decoder network includes one or more optically transmissive and/or reflective substrate layers arranged in the optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive secondary optical waves scattered by the opaque occlusion and/or diffusive medium and optically generate the message or signal at an output field-of-view. One or more messages or signal are input to the electronic encoder network so as to generate the phase-encoded and/or amplitude-encoded optical representation of the message or signal and optically generating the message or signal at the output field-of-view.

### BRIEF DESCRIPTION OF THE DRAWINGS

FIG. 1A schematically illustrates a system for the display or projection of high-resolution images. The system is able to display high-resolution/super-resolution images using a front-end digital encoder and a back-end all-optical diffractive decoder. FIG. 1A illustrates the all-optical decoder network embodied in a wearable device such as a wearable headset for virtual reality or augmented reality applications.

FIG. 1B illustrates schematically how the device of FIG. 1A may be used to project a high-resolution/super-resolution image onto a surface such as an eye of a mammal.

FIG. 2 illustrates a single substrate layer of an all-optical decoder network. The substrate layer may be made from a material that is optically transmissive (for transmission mode) or an optically reflective material (for reflective mode). The substrate layer, which may be formed as a substrate or plate in some embodiments, has surface features formed across the substrate layer. The surface features form a patterned surface (e.g., an array) having different valued transmission (or reflection) properties as a function of lateral coordinates across each substrate layer. These surface features act as artificial “neurons” that connect to other “neurons” of other substrate layers of the optical neural network through optical diffraction (or reflection) and alter the phase and/or amplitude of the light wave.

FIG. 3 schematically illustrates a cross-sectional view of a single substrate layer of an all-optical decoder network according to one embodiment. In this embodiment, the surface features are formed by adjusting the thickness of the substrate layer that forms the all-optical decoder network. These different thicknesses may define peaks and valleys in the substrate layer that act as the artificial “neurons.”

FIG. 4 schematically illustrates a cross-sectional view of a single substrate layer of an all-optical decoder network according to another embodiment. In this embodiment, the different surface features are formed by altering the material composition or material properties of the single substrate layer at different lateral locations across the substrate layer. This may be accomplished by doping the substrate layer with a dopant or incorporating other optical materials into the substrate layer. Metamaterials or plasmonic structures may also be incorporated into the substrate layer.

FIG. 5 schematically illustrates a cross-sectional view of a single substrate layer of an all-optical decoder network according to another embodiment. In this embodiment, the substrate layer is reconfigurable in that the optical properties of the various artificial neurons may be changed, for example, by application of a stimulus (e.g., electrical current or field). An example includes spatial light modulators (SLMs) which can change their optical properties. In this embodiment, the neuronal structure is not fixed and can be dynamically changed or tuned as appropriate. This embodiment, for example, can provide a learning optical neural network or a changeable optical neural network that can be altered on-the-fly (e.g., over time) to improve the performance, compensate for aberrations, or even change another task.

FIGS. 6A-6B schematically illustrate a super-resolution (SR) image display system composed of an all-electronic encoder and an all-optical decoder network. FIG. 6A: building blocks of a super-resolution image display system composed of an all-electronic encoder and an all-optical decoder network including 5 diffractive modulation layers are shown. An all-electronic encoder network is used to create low resolution representations of the input images, which are then super-resolved using the diffractive optical decoder, achieving a desired SR factor (k>1). FIG. 6B: Optical layout of the 5-layer diffractive decoder network, d₁=2.6671, d₂=66.6671, d₃=801.

FIG. 7 illustrates image projection results of the diffractive SR display using a phase-only SLM. Top: Image projection results of the SR display using 5 diffractive layers (L=5). Middle row: Image projection results of the SR display using 3 diffractive layers (L=3). Bottom: Image projection results of the SR display using 1 diffractive layer (L=1). For comparison, low resolution versions of the same images using the same number of pixels as the corresponding wavefront modulator are illustrated on the right side of the FIG.

FIGS. 8A-8B illustrates quantification of the image projection performance of the diffractive SR display as a function of k and L. The test image dataset contains 6000 images, each containing multiple EMNIST handwritten letters. FIG. 8A: average PSNR values for phase-only (left) and complex-valued (right) encoding. FIG. 8B: average SSIM values for phase-only (left) and complex-valued (right) encoding.

FIG. 9 illustrates image resolution analysis of the diffractive SR display using a phase-only SLM. Projections of vertical and horizontal line-pairs with a linewidth of 2.132λ are demonstrated for different SR factors (k=4, 6, and 8). Diffractive all-optical decoder networks with different numbers of diffractive layers (L=1, 3, and 5) project super-resolved images at the output. For comparison, low resolution (LR) versions of the same objects using the same number of pixels as the corresponding wavefront modulator are illustrated on the right side of FIG. 9. The diffractive SR systems were trained using handwritten letters and the training dataset did not include any resolution test targets or line pairs.

FIGS. 10A-10D illustrates the experimental setup for a 3-layer diffractive SR decoder. A 3-layer diffractive SR decoder is vaccinated against both lateral (Δ_{x,y}=˜0.334λ) and axial (Δ_{z}=˜0.5331) misalignments and trained for an SR factor of k=3. The all-electronic encoder creates phase-only LR representations of the images to be projected. FIG. 10A: phase profiles of the trained diffractive decoder layers used in the experiments. FIG. 10B: optical layout of the 3-layer diffractive SR decoder. FIG. 10C: photograph of the 3D-printed diffractive SR decoder network. FIG. 10D: schematic of the experimental setup using continuous wave THz illumination.

FIG. 11: Experimental results of the diffractive SR image display system with L=3 layers. Encoded phase-only representations of the objects are obtained using the all-electronic encoder. The all-optical diffractive decoder projects super-resolved images. For comparison, low resolution versions of the same images using the same number of pixels as the corresponding wavefront modulator are illustrated at the bottom row of FIG. 11.

FIGS. 12A-12C: Experimental setup for a 1-layer diffractive SR decoder. A 1-layer diffractive SR decoder is vaccinated against both lateral (Δ_{x,y}=˜0.3341) and axial (Δ_{z}=˜0.5331) misalignments and trained for an SR factor of k=3. The all-electronic encoder creates phase-only LR representations of the images to be projected. FIG. 12A: phase profile of the trained diffractive decoder layer used in the experiments. FIG. 12B: optical layout of the 1-layer diffractive SR decoder. FIG. 12C: photograph of the 3D-printed diffractive SR decoder network.

FIG. 13: Experimental results of the diffractive SR image display system with L=1 layer. Encoded phase-only representations of the objects are obtained using the all-electronic encoder. The all-optical diffractive decoder projects super-resolved images. For comparison, low resolution versions of the same images using the same number of pixels as the corresponding wavefront modulator are illustrated at the bottom row of FIG. 13.

FIG. 14: Quantization analysis of the phase-only wavefront modulation for synthesized images. Image projection results of the SR display using 5 diffractive layers (L=5) are demonstrated for different phase quantization levels (16-, 8-, 6-, 4-, and 2-bit). The encoding-decoding framework is trained for 16-bit phase quantization of the SLM patterns and blindly tested for lower quantization levels.

FIG. 15: Image projection results of the diffractive SR display using complex-valued image encoding. Top: Image projection results of the SR display using 5 diffractive layers (L=5). Middle row: Image projection results of the SR display using 3 diffractive layers (L=3). Bottom: Image projection results of the SR display using 1 diffractive layer (L=1). For comparison, low resolution versions of the same images are illustrated on the right side of FIG. 15.

FIG. 16 illustrates image projection results of the diffractive SR display using an amplitude-only SLM. Image projection results of the SR display using 5 diffractive layers (L=5). For comparison, low resolution versions of the same images using the same number of pixels as the corresponding wavefront modulator are illustrated on the right side of the FIG. 16.

FIG. 17: Image resolution analysis of the diffractive SR display using complex-valued image encoding. Projections of vertical and horizontal line-pairs with a linewidth of 2.1321 are tested under different SR factors (k=4, 6, and 8). Diffractive all-optical decoder networks with different numbers of diffractive layers (L=1, 3, and 5) project super-resolved images at the output FOV. For comparison, low resolution versions of the same images are illustrated on the right side of the FIG. The diffractive SR systems were trained using handwritten letters and the training dataset did not include any resolution test targets or line pairs.

FIG. 18: Image generation for the EMNIST display dataset. Different number of EMNIST handwritten letters were randomly selected and augmented by a set of predefined operations including scaling (K˜U(0.84, 1)), rotation (Θ˜U(−5, °5°)), and translation (Dₓ, D_{y}˜U(−1.06λ, 1.06λ) as detailed in the Methods section of the main text. These randomly selected and augmented handwritten letters were placed at randomly chosen locations in a 3×3 grid for each image in the EMNIST display dataset.

FIG. 19: Phase profiles of the trained diffractive decoder layers using a phase-only SLM at the input of each decoder. Each diffractive layer has a size of 106.66λ×106.66λ, with a diffractive neuron size of 0.533λ×0.533λ.

FIG. 20A illustrates a schematic of the optical communication framework around fully opaque occlusions using electronic encoding and diffractive all-optical decoding. An electronic neural network encoder and an all-optical diffractive decoder are trained jointly for communicating around an opaque occlusion. For a message/object to be transmitted, the electronic encoder outputs a coded 2D phase pattern, which is imparted onto a plane wave at the transmitter aperture. The phase-encoded wave, after being obstructed and scattered by the fully opaque occlusion, travels to the receiver, where the diffractive decoder all-optically processes the encoded information to reproduce the message on its output FOV.

FIG. 20B illustrates the architecture used for the convolutional neural network (CNN) electronic encoder network.

FIG. 20C illustrates visualization of different processes, such as the obstruction of the transmitted phase-encoded wave by the occlusion of width wₒ and the subsequent all-optical decoding performed by the diffractive decoder. The diffractive decoder comprises L surfaces (S₁, . . . , S_{L}) with phase-only diffractive features. In FIG. 20C, L=3 is illustrated as an example.

FIG. 20D illustrates a comparison of the encoding-decoding scheme (diffractive decoder output) against conventional lens-based imaging (lens image).

FIG. 21 illustrates generalization of trained encoder-decoder pairs to previously unseen handwritten digit objects. For different values of the occlusion width wₒ, the performances of trained encoder-decoder pairs with different numbers of decoder layers (L) are depicted for comparison.

FIGS. 22A and 22B shows quantification of the performance of encoder-decoder pairs with different numbers of decoder layers (L) trained for increasing occlusion widths (wₒ) in terms of PSNR (FIG. 22A) and SSIM (FIG. 22B) between the diffractive decoder outputs and the ground-truth messages. The PSNR and SSIM values are calculated by averaging over 10,000 MNIST test images, wₜ refers to the width of the transmitter aperture.

FIG. 23 is the same as FIG. 21, except that these results reflect external generalizations on object types different from those used during the training.

FIG. 24 illustrates output resolution of diffractive decoders corresponding to L=1, L=3, and L=5 designs trained for different occlusion widths (wₒ). As for the objects, the vertical/horizontal separation between the inner edges of the dots is 2.12λ for the test pattern on the top and 4.24λ for the test pattern located on the bottom. The diffractive decoder outputs are accompanied by cross-sections taken along the vertical/horizontal lines.

FIG. 25A illustrates the effect of the phase bit depth of the encoded object and the diffractive layer features on the performance of trained encoder-decoder pairs. Qualitative performance of the designs, which are trained assuming a certain phase quantization bit depth b_{q,tr}, reported as a function of the bit depth used during testing b_{q,te}. (b)

FIG. 25B illustrates for different b_{q,tr}, plotted PSNR and SSIM values as a function of b_{q,te}. The PSNR and SSIM values are evaluated by averaging the results of 10,000 test images from the MNIST dataset.

FIGS. 26A-26C illustrate the output power efficiency of the electronic encoding-diffractive decoding scheme for optical communication around fully opaque occlusions. FIG. 26A is a graph of diffraction efficiency (DE) of the same designs shown in FIGS. 22A, 22B. FIG. 26B shows the trade-off between DE and SSIM achieved by varying the training hyperparameter η, i.e., the weight of an additive loss term used for penalizing low-efficiency designs. For these designs, wₒ=32λ and L=3 were used. The DE and SSIM values are calculated by averaging over 10,000 MNIST test images. FIG. 26C shows the performance of some of the designs shown in FIG. 26B, trained with different η values.

FIGS. 27A-27E illustrates the performance of encoder-decoder pairs trained for different opaque occlusion shapes. The performances of four designs trained for different occlusion shapes, i.e., a square, a circle, a rectangle, and an arbitrary shape, are shown. The areas of these fully opaque occlusions are approximately equal.

FIG. 28A illustrates the terahertz setup comprising the source and the detector, together with the 3D-printed components used as the encoded phase objects, the occlusion, and the diffractive layer. Experimental results with an L=1 design for an occlusion width of wₒ=32λ operating at a wavelength of λ=0.75 mm.

FIG. 28B illustrates the assembly of the encoded phase objects, the occlusion, the diffractive layer, and the output aperture using a 3D-printed holder.

FIG. 28C shows the encoded phase object (one example), the occlusion, and the diffractive layer are shown separately, housed inside the supporting frames.

FIG. 28D illustrates the experimental diffractive decoder outputs (bottom row) for ten handwritten digit objects (top row), together with the corresponding simulated lens images (second row) and the diffractive decoder outputs (third row).

FIG. 29 illustrates examples of the custom-prepared training images.

FIG. 30 illustrates a histogram of average SSIM values of the diffractive decoder outputs for the four designs of FIGS. 27A-27E, calculated over 10,000 test images from the MNIST dataset (internal generalization) and the Fashion-MNIST dataset (external generalization).

FIG. 31 illustrates transfer learning of the CNN encoder at the transmitter, while the diffractive decoder at the receiver remains unchanged, for successful communication in case of an increase/change in the size of the opaque occlusion, obstructing the transmitter field-of-view.

FIG. 32 illustrates the importance of diffractive decoding for optical communication around fully opaque occlusions. Designs with no diffractive decoders are compared against the designs with L=1 layer diffractive decoders for two different sizes of occlusion width (wₒ).

### DETAILED DESCRIPTION OF ILLUSTRATED EMBODIMENTS

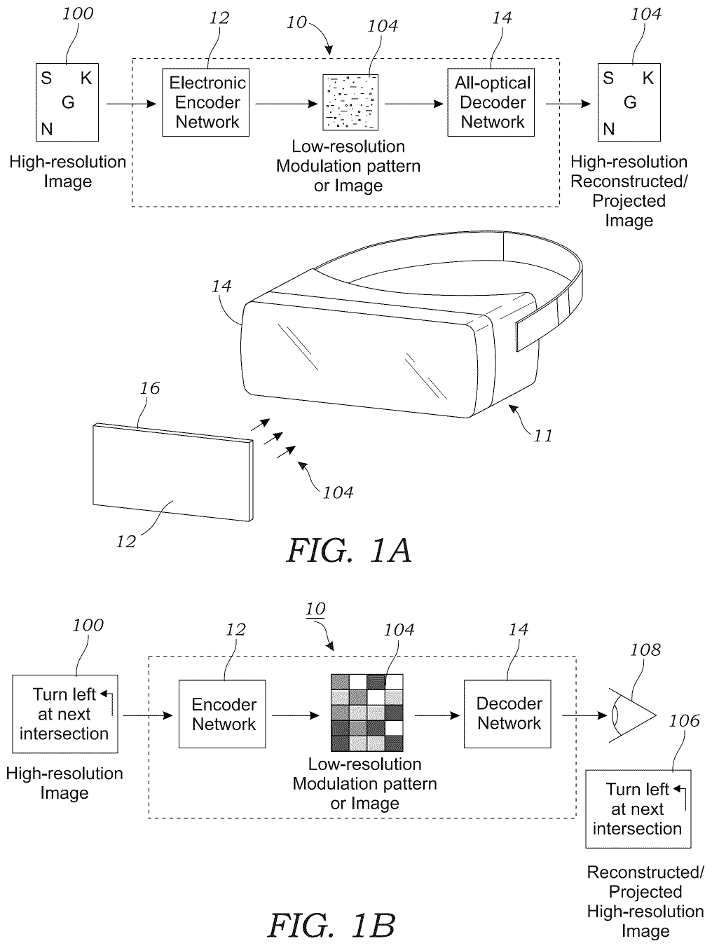

FIG. 1A illustrates an embodiment of a system 10 for the display or projection of high-resolution images 100. The system 10 may, in some embodiments, include aspects that may be incorporated into a portable or wearable device 11. For example. FIG. 1A illustrates parts of the system 10 embodied in a headset (or glasses) as the portable or wearable device 11 that may be used, for example, for virtual reality or augmented reality applications. Of course, the system 10 is not so limited. Additional applications of the system 10 include displays used in transportation or conveyances (e.g., heads-up displays, console displays, and the like). The system 10 may also be used in advertising (digital billboards, digital signage, security settings, surgery, and the like.

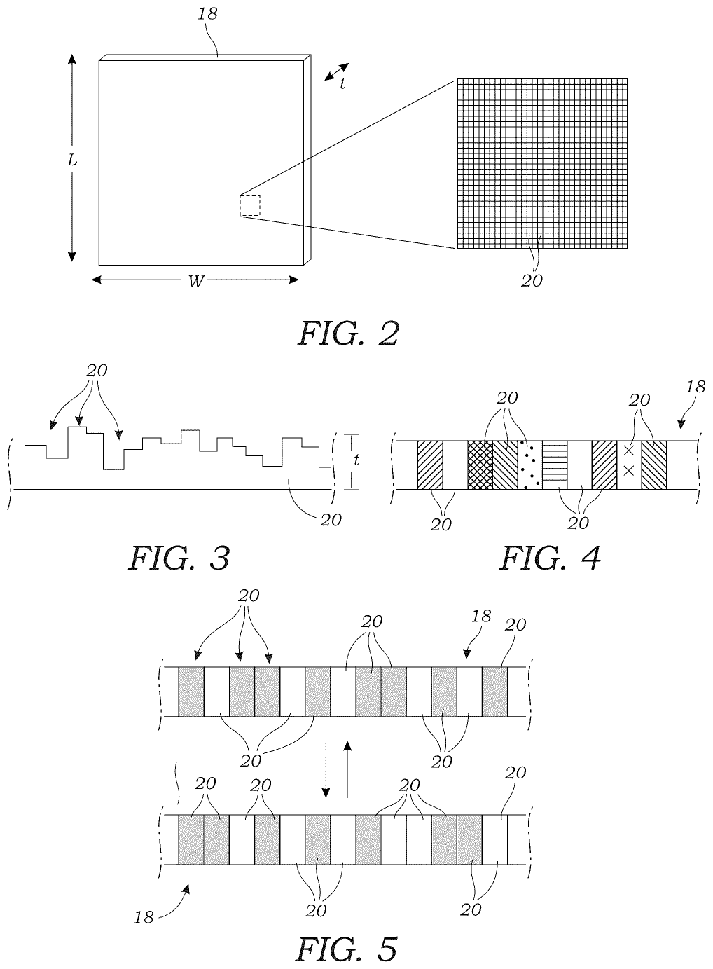

The system 10 uses a pair of jointly-trained electronic encoder network 12 along with a digital version or model of the all-optical decoder network 14. In one aspect, the electronic encoder network 12 includes a trained deep neural network, which in one preferred embodiment, is a trained convolutional neural network (CNN). The trained electronic encoder network 12 receives one or more high-resolution images 100 and, with an associated image generator 16, generates corresponding low-resolution modulation patterns or images 104 representative of the one or more high-resolution images 100. The low-resolution modulation patterns or images 104 are generated by the image generator 16. Examples of the image generators 16 include, by way of illustration and not limitation, a display, a projector, a screen, a spatial light modulator (SLM), or a wavefront modulator. The low-resolution modulated patterns or images 104 may include phase-only modulation, amplitude-only modulation, or complex modulation. The low-resolution modulation patterns or images 104 are then input to the physical all-optical decoder network 14 including one or more optically transmissive and/or reflective substrate layers 18 (also referred to herein as diffractive layers) arranged in an optical path. The optical path may be straight or folded. Each of the optically transmissive and/or reflective substrate layer(s) 18 include a plurality of physical features 20 (e.g., FIGS. 2-5) formed on or within the one or more optically transmissive and/or reflective substrate layers 18 and having different transmission and/or reflective properties as a function of local coordinates (e.g., length and width) across each substrate layer 18. In the experimental system 10) described herein, the all-optical decoder network 14 operates in a transmission mode in which light transmits/diffracts through the substrate layer(s) 18. In other embodiments, the all-optical decoder network 14 operates in a reflection mode where light reflects/diffracts off the substrate layer(s) 18. In addition, in some embodiments, the system 10 may also include substrate layer(s) 18 that operate in both transmission and reflection mode.

With reference to FIGS. 2-5, the physical features 20 on or in the substrate layers 18 form the neurons of the all-optical decoder network 14. In some embodiments, each separate physical feature 20 may define a discrete physical location on the substrate layer 18 while in other embodiments, multiple physical features 20 may combine or collectively define a physical region with a particular transmission (or reflection) property. The one or more substrate layers 18 arranged along the optical path collectively generate the reconstructed high-resolution/super-resolution image 106. During operation of the system, the one or more optically transmissive and/or reflective substrate layers 18 with the plurality of physical features 20 receive light resulting from the low-resolution modulation patterns or images 104 representative of the one or more high-resolution images 100 and optically generate corresponding high-resolution image reconstructions or projections 106 at an output field-of-view. The all-optical decoder network 14 projects high-resolution/super-resolved reconstruction or projection images 106 at the output while maintaining the size of the image field-of-view (FOV), thereby surpassing the SBP restrictions enforced by the wavefront modulator or the SLM. The system 10 may operate at any number of wavelengths within the electromagnetic spectrum. This includes, for example, ultra-violet wavelengths, visible wavelengths, infrared wavelengths, THz wavelengths (which are used in experiments as explained herein), or millimeter wavelengths.

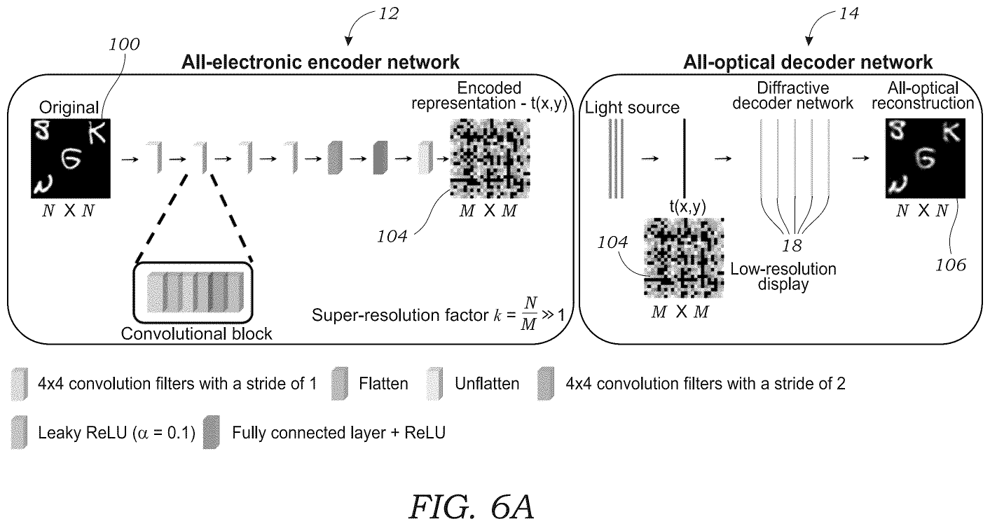

FIG. 3 illustrates one embodiment of how different physical features 20 are formed in the substrate layer 18. In this embodiment, a substrate layer 18 has different thicknesses (t) of material at different lateral locations along the substrate layer 18. In one embodiment, the different thicknesses (t) modulate the phase of the light passing through the substrate layer 18. The different thicknesses of material in the substrate layer 18 forms a plurality of discrete “peaks” and “valleys” that control the transmission properties of the neurons formed in the substrate layer 18. The different thicknesses of the substrate layer 18 may be formed using additive manufacturing techniques (e.g., 3D printing) or lithographic methods utilized in semiconductor processing. For example, the design of the substrate layer(s) 18 may be stored in a stereolithographic file format (e.g., .stl file format) which is then used to 3D print the substrate layer(s) 18 that form the all-optical decoder network 14. Other manufacturing techniques include well-known wet and dry etching processes that can form very small lithographic features on a substrate layer 18. Lithographic methods may be used to form very small and dense physical features 20 on the substrate layer 18 which may be used with shorter wavelengths of the light. As seen in FIG. 3, in this embodiment, the physical features 20 are fixed in permanent state (i.e., the surface profile is established and remains the same once complete).

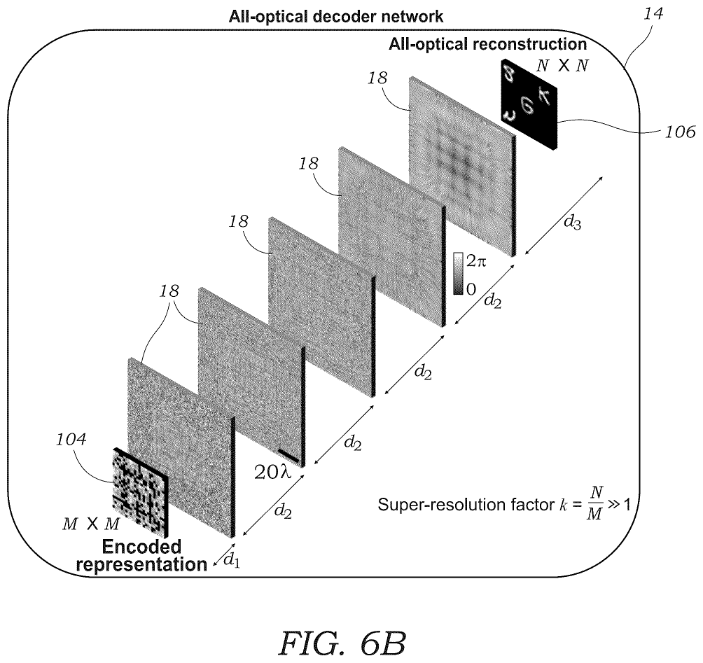

FIG. 4 illustrates another embodiment in which the physical features 20 are created or formed within the substrate layer 18. In this embodiment, the substrate layer 18 may have a substantially uniform thickness but have different regions of the substrate layer 18 have different optical properties. For example, the refractive (or reflective) index of the substrate layer(s) 18 may be altered by doping the substrate layer(s) 18 with a dopant (e.g., ions or the like) to form the regions of neurons in the substrate layer(s) 28 with controlled transmission properties (and/or absorption and/or spectral features). In still other embodiments, optical nonlinearity can be incorporated into the deep optical network design using various optical non-linear materials (e.g., crystals, polymers, semiconductor materials, doped glasses, polymers, organic materials, semiconductors, graphene, quantum dots, carbon nanotubes, and the like) that are incorporated into the substrate layer 18. A masking layer or coating that partially transmits or partially blocks light in different lateral locations on the substrate layer 18 may also be used to form the neurons on the substrate layer(s) 18.

Alternatively, the transmission function of the physical features 20 or neurons can also be engineered by using metamaterial, and/or metasurfaces (e.g., surfaces with sub-wavelength, nano-scale structures which lead to special optical properties), and/or plasmonic structures. Combinations of all these techniques may also be used. In other embodiments, non-passive components may be incorporated in into the substrate layer(s) 18 such as spatial light modulators (SLMs). SLMs are devices that impose spatial varying modulation of the phase, amplitude, or polarization of light. SLMs may include optically addressed SLMs and electrically addressed SLM. Electric SLMs include liquid crystal-based technologies that are switched by using thin-film transistors (for transmission applications) or silicon backplanes (for reflective applications). Another example of an electric SLM includes magneto-optic devices that use pixelated crystals of aluminum garnet switched by an array of magnetic coils using the magneto-optical effect. Additional electronic SLMs include devices that use nanofabricated deformable or moveable mirrors that are electrostatically controlled to selectively deflect light.

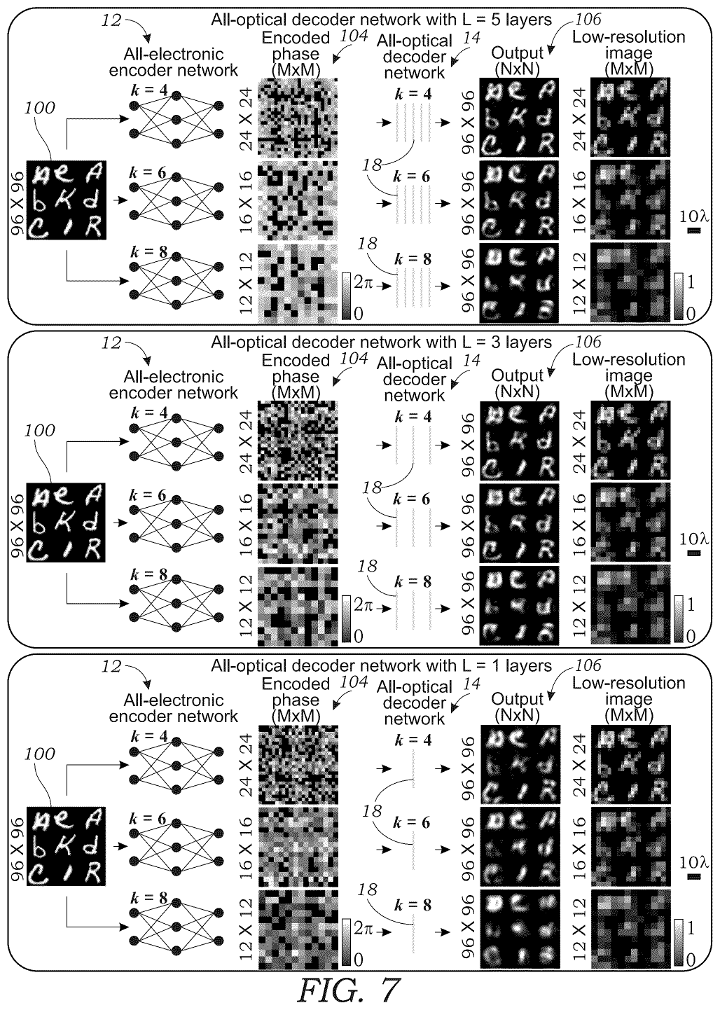

FIG. 5 schematically illustrates a cross-sectional view of a single substrate layer 18 of the all-optical decoder network 14 according to another embodiment. In this embodiment, the substrate layer 18 is reconfigurable as a function of time in that the optical properties of the various physical features 20 that form the artificial neurons may be changed, for example, by application of a stimulus (e.g., electrical current or field). An example includes spatial light modulators (SLMs) discussed above which can change their optical properties. The substrate layers(s) 18 may incorporate at least one nonlinear optical material. In other embodiments, the layers may use the DC electro-optic effect to introduce optical nonlinearity into the substrate layer(s) 18 of the all-optical decoder network 14 and require a DC electric-field for each substrate layer 18. This electric-field (or electric current) can be externally applied to each substrate layer 18. Alternatively, one can also use poled materials with very strong built-in electric fields as part of the material (e.g., poled crystals or glasses). In this embodiment, the neuronal structure is not fixed and can be dynamically changed or tuned as appropriate (i.e., changed on demand). This embodiment, for example, can provide a learning or changeable all-optical decoder network 14 that can be altered on-the-fly to improve the performance, compensate for aberrations, or even change another task.

In some embodiments, the high-resolution reconstructed or projected image 106 may be projected onto an observation plane or surface. This may include, for example, the surface of a mammalian eye. For example, the all-optical decoder network 14 of the system 10 may be integrated into a headset, goggles, glasses, or other portable electronic device 11 (FIG. 1A) and projected onto the user's eye(s) 108 such as seen in FIG. 1B. FIG. 1B illustrates the system 10 used to display directions to a user. In this embodiment, a high-resolution image 100 is encoded into a low-resolution modulation pattern 104 by the electronic encoder network 12 which is then decoded by the all-optical decoder network 14 and generates a high-resolution image reconstruction or projection 106 for display to the user. For example, the system 10 may be integrated into head-mounted AR/VR devices for next generation display technology. The high-resolution reconstructed or projected image 106 may, in some embodiments, projected onto a FOV that is captured by one or more optical detectors.

Exemplary materials that may be used for the substrate layer(s) 18 include polymers and plastics (e.g., those used in additive manufacturing techniques such as 3D printing) as well as semiconductor-based materials (e.g., silicon and oxides thereof, gallium arsenide and oxides thereof), crystalline materials or amorphous materials such as glass and combinations of the same. Metal coated materials may be used for reflective substrate layers 18.

The pattern of physical locations formed by the physical features 20 may define, in some embodiments, an array located across the surface of the substrate layer 18. The substrate layer 18 in one embodiment is a two-dimensional generally planer substrate having a length (L), width (W), and thickness (t) that all may vary depending on the particular application. In other embodiments, the substrate layer 18 may be non-planer such as, for example, curved. In addition, while the FIG. 2 illustrates a rectangular or square-shaped substrate layer, it should be appreciated that different geometries are contemplated. The physical features 20 and the physical regions formed thereby act as artificial “neurons” that connect to other “neurons” of other substrate layers 18 of the all-optical decoder network 14 through optical diffraction (or reflection) and alter the phase and/or amplitude of the light wave. The particular number and density of the physical features 20 or artificial neurons that are formed in each substrate layer 18 may vary depending on the type of application. In some embodiments, the total number of artificial neurons may only need to be in the hundreds or thousands while in other embodiments, hundreds of thousands or millions of neurons or more may be used. Likewise, the number of substrate layers 18 that are used in a particular all-optical decoder network 14 may vary although it typically ranges from at least one substrate layer 18 to less than ten substrate layers 18.

The system 10 may be used to transmit information, messages, or data to individuals. For example, an image generator 16 such as a display, a projector, a screen, a spatial light modulator (SLM), or a wavefront modulator may generate a low-resolution modulation pattern or image 104 (or multiple patterns or images 104) from a high-resolution image 100. The low-resolution modulation pattern(s) or image(s) 104 may be viewable by any person but no useful information can be discerned from the low-resolution modulation pattern 104. However, those persons that have access to the all-optical decoder network 14 are able to reconstruct the high-resolution image 106 that is encoded by the low-resolution modulation pattern(s) or image(s) 104. This could be an image of a scene, a text message, advertisement, directions, or the like. This could also be a series of images that form a movie or image clip. In some embodiments, groups of people or even individuals may have their own unique all-optical decoder network 14 such that secure communications can be tailored to particular groups or individuals. In addition, in some embodiments, the low-resolution modulation pattern(s) or image(s) 104 may be generated as a watermark or overlapping image over another image.

### EXPERIMENTAL

### Results

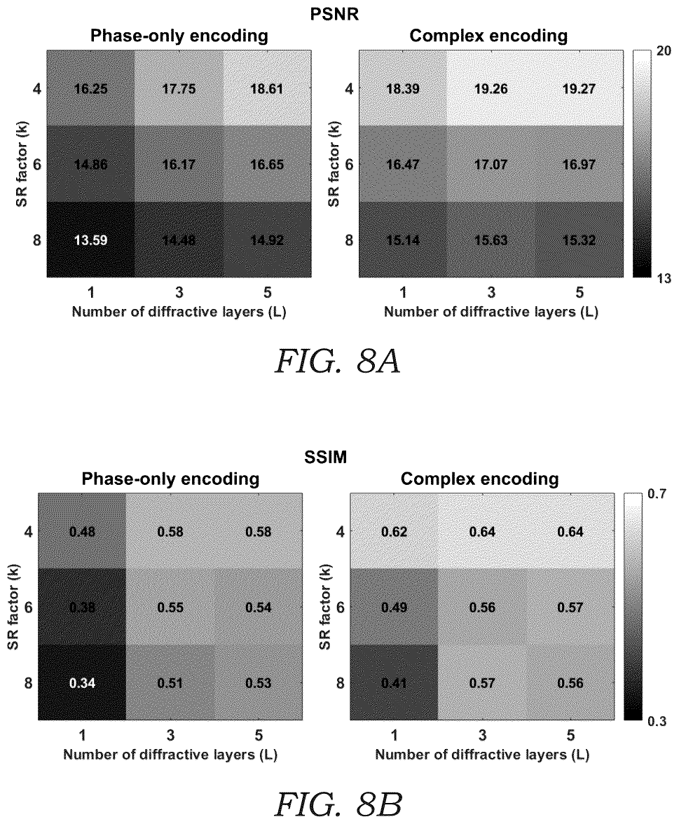

The operational principles and the building blocks of the presented diffractive SR image system 10 are depicted in FIGS. 1 and 6A, 6B. According to the forward model described in FIGS. 6A and 6B, an electronic encoder network 12 (e.g., CNN) is trained to extract the spatial features of a high-resolution image 100 (to be projected) and encode this spatial information into a lower-dimensional representation 104 with a reduced size that is equal to the physically available number of pixels on the wavefront modulator. The input beam, which is assumed to be a uniform plane wave (see FIG. 6A), is modulated by the output pattern of the encoder network 12 on the SLM, and subsequently, the resulting waves are all-optically processed by the all-optical decoder network 14, aiming to recover a high-resolution reconstruction or projection 106 of the original image at its output FOV, effectively creating a high-resolution display through all-optical super-resolution.

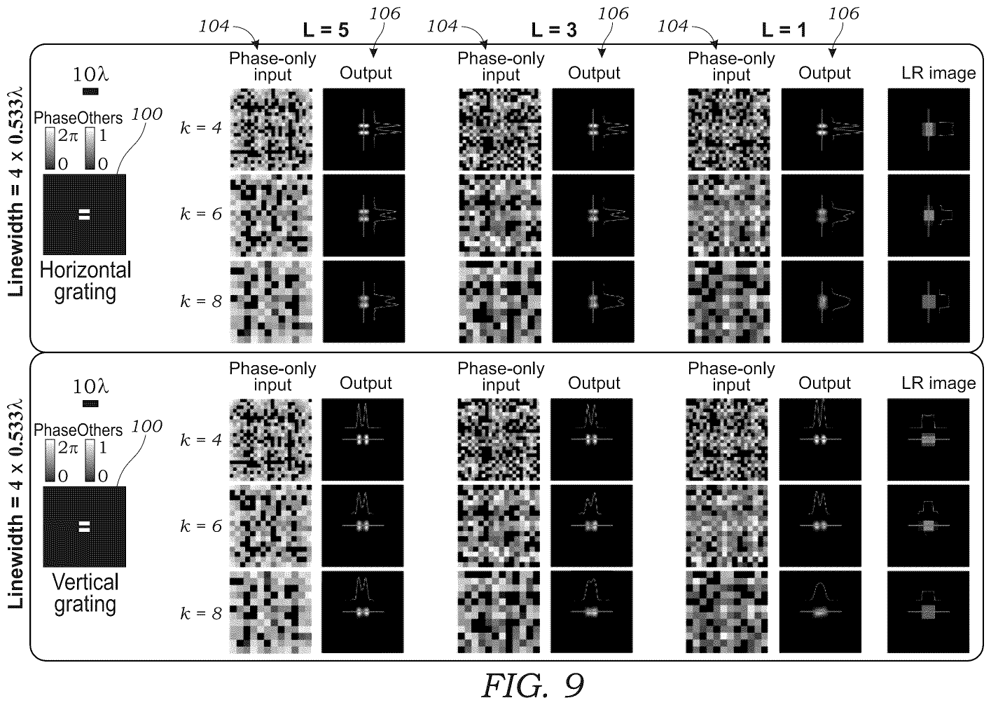

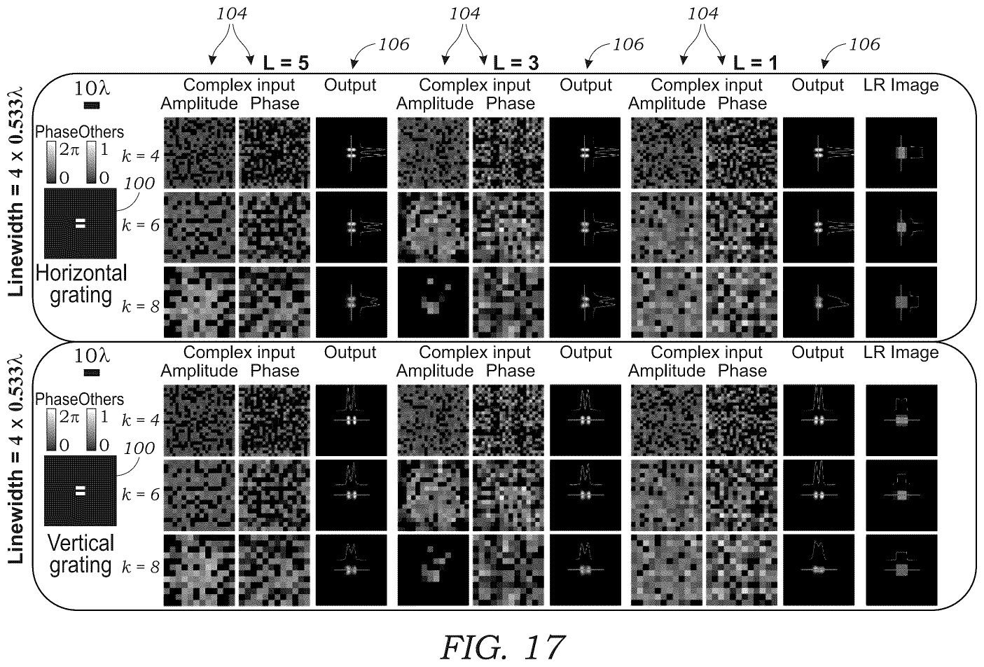

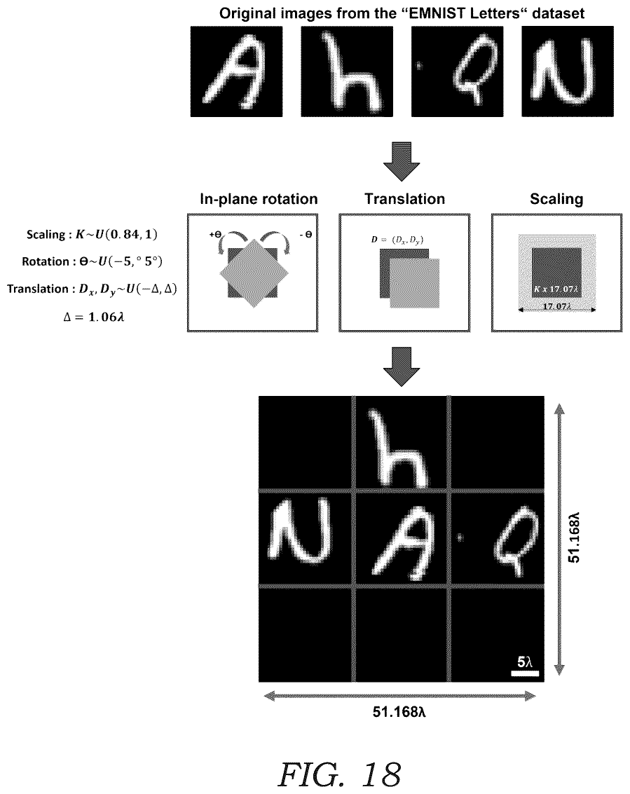

FIG. 7 demonstrates the super-resolved image projection performance (blind testing results) of the diffractive SR display system designs trained for k=4, k=6, and k=8 SR factors in both x and y directions. The training details of these diffractive SR displays with different configurations are described in the Methods section. Note that for each case (k=4, 6, and 8), the input and output fields-of-view, i.e., the sizes of the wavefront modulator and the output image, are kept identical and therefore, the pixel size of the wave modulators for each SR factor is given as: k×0.533λ corresponding to 2.132λ, 3.198λ and 4.264λ for k=4, 6 and 8, respectively. Another important design parameter besides the SR factor (k) is the number of the substrate layers 18, L, used in the all-optical decoder network 14 design. FIG. 7 also provides a comparison among different decoders using L=1, 3, and 5 diffractive layers 18 trained for SR factors of k=4, 6, and 8. For the results shown in FIG. 7, the wavefront modulator 16 was assumed to provide phase-only modulation of the incoming fields; the results of a similar analysis with a complex-valued SLM at the input of each all-optical decoder network 14 are also presented in FIG. 15. Furthermore, FIG. 16 reports the results of an amplitude-only wavefront modulator 16 used at the electronic encoder network 12.

In FIG. 7, FIGS. 15 and 16, one can see that the cases with k≥4 describe a very low-resolution SLM 16 with a large pixel size and a small number of pixels, for which the native resolution is insufficient to directly represent most of the details of the test objects (EMNIST handwritten letters) within the FOV. On the other hand, these spatial features can be recovered all-optically through the all-optical decoder network 14, projecting SR images 106 at its output FOV, as illustrated in FIG. 7 and FIGS. 15-16. It was also observed that, for a fixed SR factor, k, the discrepancies between the desired high-resolution images and the optically synthesized intensity distributions at the output FOV of the all-optical decoder network 14 become smaller as the number of diffractive layers 18, L, increases, demonstrating the advantage of deeper all-optical decoder networks 14 to provide better image projection.

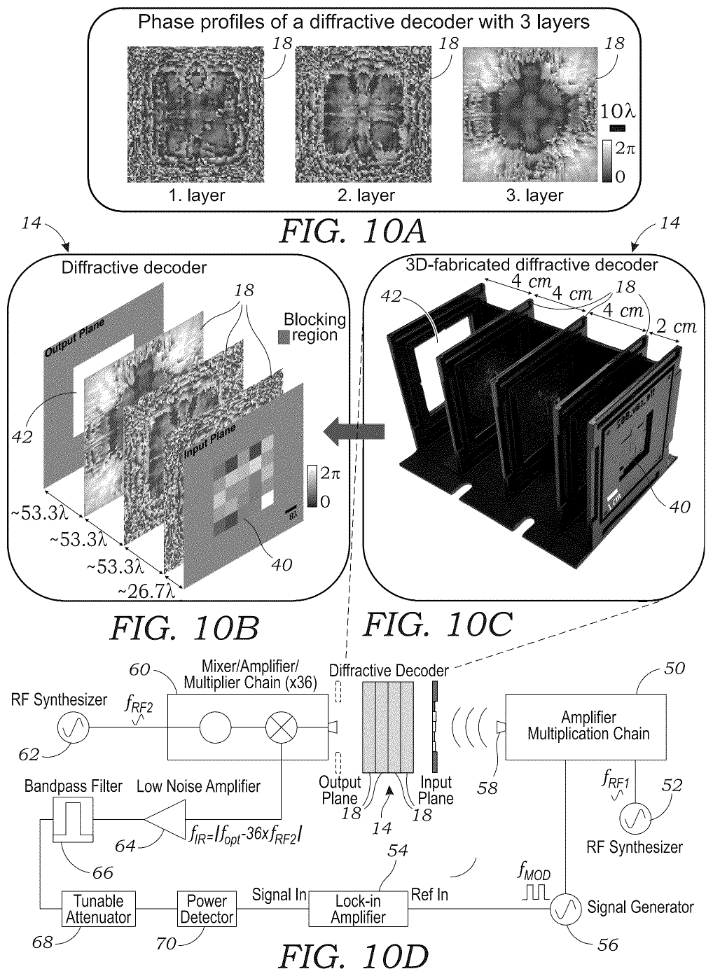

Beyond the visual inspections and comparisons provided in FIG. 7 and FIGS. 15 and 16, the efficacy of the diffractive SR display framework is also confirmed by quantifying the image quality using the structural similarity index measure (SSIM) and the peak signal-to-noise ratio (PSNR) metrics. As part of this quantitative analysis, FIGS. 8A, 8B compares the overall image synthesis performance of phase-only and complex-valued wavefront modulation at the input plane of the all-optical decoder networks 14. On average, complex-valued wavefront modulation provides slightly better PSNR and SSIM values at the output of the diffractive decoder compared to the phase-only modulation/encoding because of the increased degrees of freedom. FIGS. 8A, 8B also supports the conclusion of FIG. 7 that the deeper all-optical decoder networks 14 with a larger number of diffractive layers 18 overall perform higher fidelity output image projection 106.

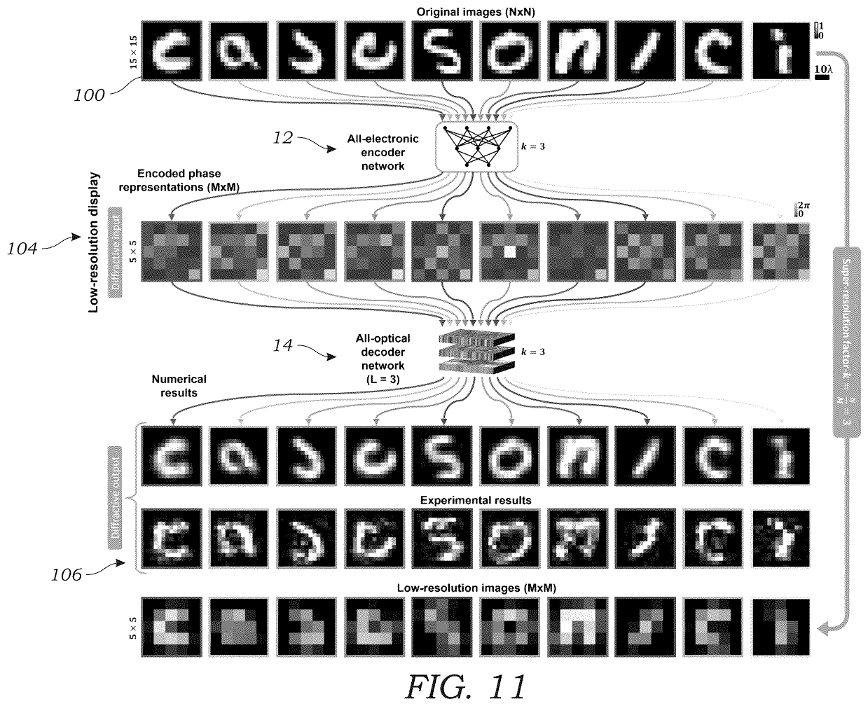

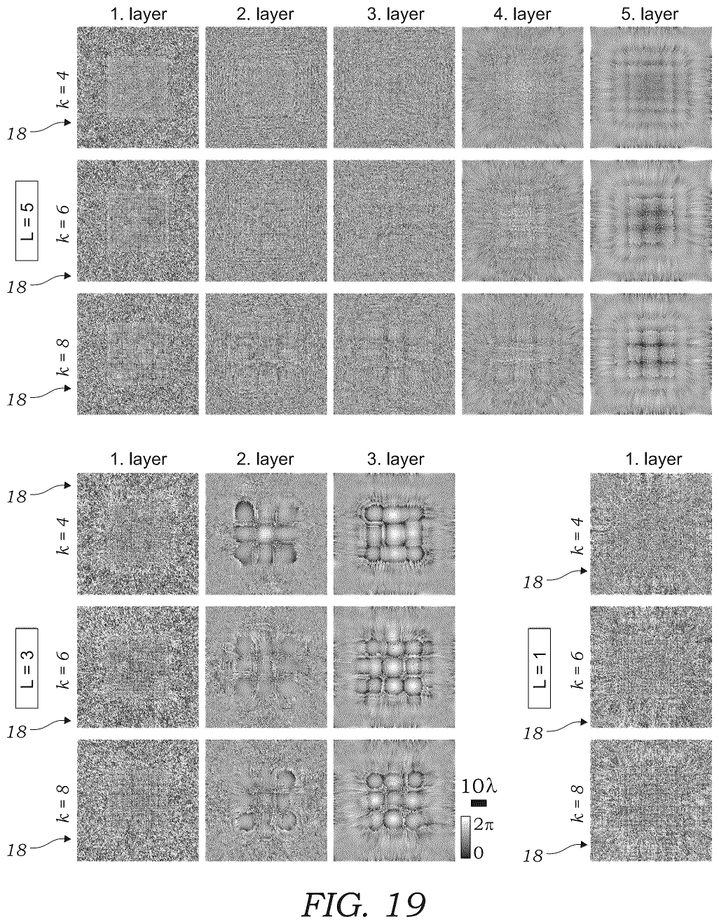

To provide more insights into the success of the all-optical decoder networks 14 in synthesizing super-resolved images 106, additional blinded tests were conducted using the images of various lines with subpixel linewidths compared to the native phase-only SLM resolution, as shown in FIG. 9. It is important to emphasize that the training of the diffractive SR systems 10 entirely relied on the EMNIST handwritten letters dataset; hence, these new images 100 of resolution test lines represent a blind testing dataset that is statistically different from the training data. These resolution test results summarized in FIG. 9 for phase-only encoding reveal that even for deeply subpixel linewidths, the individual lines in both the horizontal and vertical structures can be resolved at the output of the 5-layer all-optical decoder network 14; see for example, 2.132λ lines, encoded through a phase-only SLM with a pixel size of 4.264λ. On the other hand, the all-optical decoder network 14 with a single diffractive layer 18 (L=1) fails to resolve the individual lines with a linewidth of 2.132λ for k=8 (FIG. 9) due to the limited generalization capability offered by the 1-layer diffractive decoder architecture. FIG. 17 also illustrates the same resolution test analysis except for a diffractive SR display system 10 using complex-valued encoding at the SLM, arriving at similar conclusions. It should be appreciated that, in other embodiments, the low-resolution modulation patterns or images 104 may be encoded in amplitude-only.

These results, summarized in FIG. 9, demonstrate that 2.132λ linewidth test images 100 composed of vertical and horizontal line pairs can be resolved through the L=5 diffractive decoder trained with an SR factor of k=8 using a phase-only wavefront modulator 16 with a native pixel size of 4.264λ, i.e., k×0.533λ. This indicates that the effective pixel size at the output plane of this all-optical decoder network 14 is ˜1.066λ (half of the minimum resolvable linewidth) which corresponds to a pixel super-resolution factor of ˜4-fold and an SBP increase of ˜16-fold. For comparison, the same resolution test target images 100 with a linewidth of 2.132λ cannot be resolved, as expected, by low-resolution displays that have a pixel size of 2.132λ or larger, as shown in FIG. 9 right column. However, the diffractive SR display system 10 with L=5 and k=8 successfully resolved these lines using a pixel size of 4.264λ at the phase-only wavefront encoder, corresponding to ˜16-fold increase in the SBP of the image display system 10. It should be noted that this increase in the SBP is smaller than k², which indicates that the training image set (handwritten EMINST letters) did not have sufficient representation of higher resolution features to guide the joint-training of the encoder-decoder pair to achieve even higher resolution image display; furthermore, such resolution test targets composed of lines or gratings were not included in the training data.

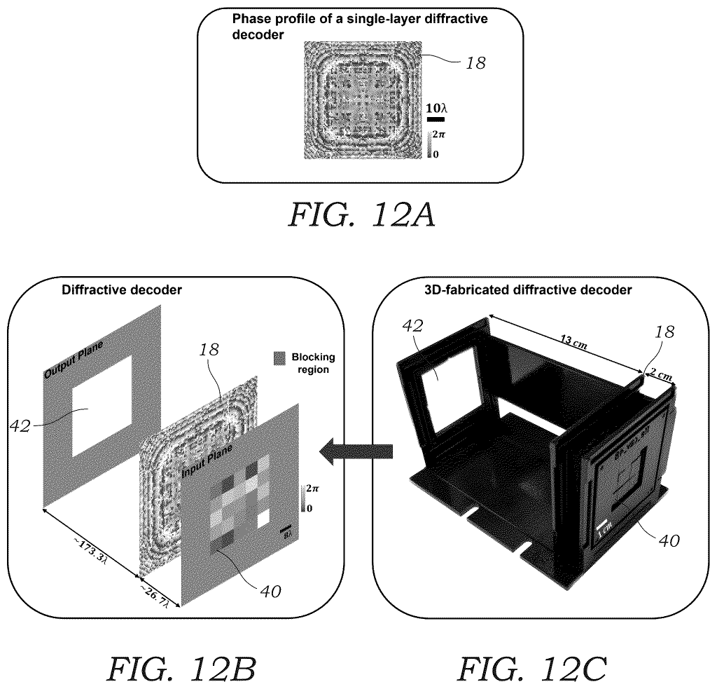

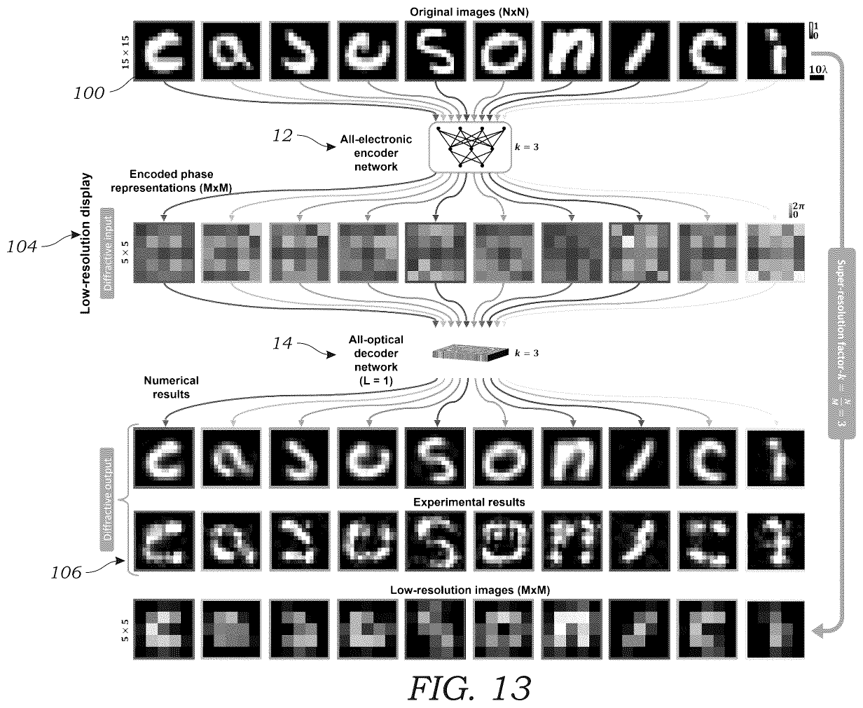

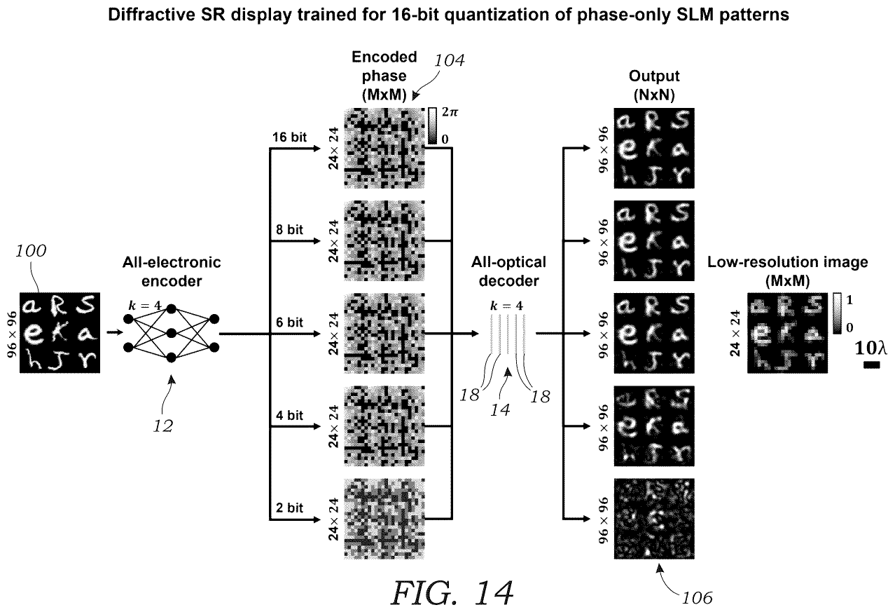

Next, to experimentally demonstrate the success of the presented SR image display system 10, two different all-optical diffractive decoder networks 14 were designed for operation at the THz part of the spectrum (see the Methods section for details). The first all-optical diffractive decoder network 14 uses a 3-layer diffractive decoder design (FIGS. 10A-10D and 11), and the second all-optical diffractive decoder network 14 (FIGS. 12A-12C) relies only on a single diffractive surface, L=1, to achieve image SR. These all-optical diffractive decoder networks 14 were 3D-printed and physically assembled/aligned to operate under continuous-wave THz illumination at λ=˜0.75 mm (see the Methods section). The experimental setup, the 3D-printed substrate layers 18 in the all-optical diffractive decoder networks 14, and the phase profiles of the fabricated optimized substrate layers 18 are illustrated in FIGS. 10A-10D and 12A-12C, for the 3-layer and 1-layer all-optical diffractive decoder networks 14, respectively. As detailed in the Methods section, the training loss function of these fabricated all-optical diffractive decoder networks 14 included an additional penalty term regularizing the output diffraction efficiency, which is on average 2.39% and 3.29% for the 3-layer and 1-layer all-optical diffractive decoder networks 14, respectively, for the blind test images. Furthermore, these all-optical diffractive decoder networks 14 were trained to be resilient against layer-to-layer misalignments in x, y, and z directions using a vaccination strategy (outlined in the Methods section) that randomly introduces 3D misalignments during the training process, which was shown to create misalignment tolerant diffractive designs.

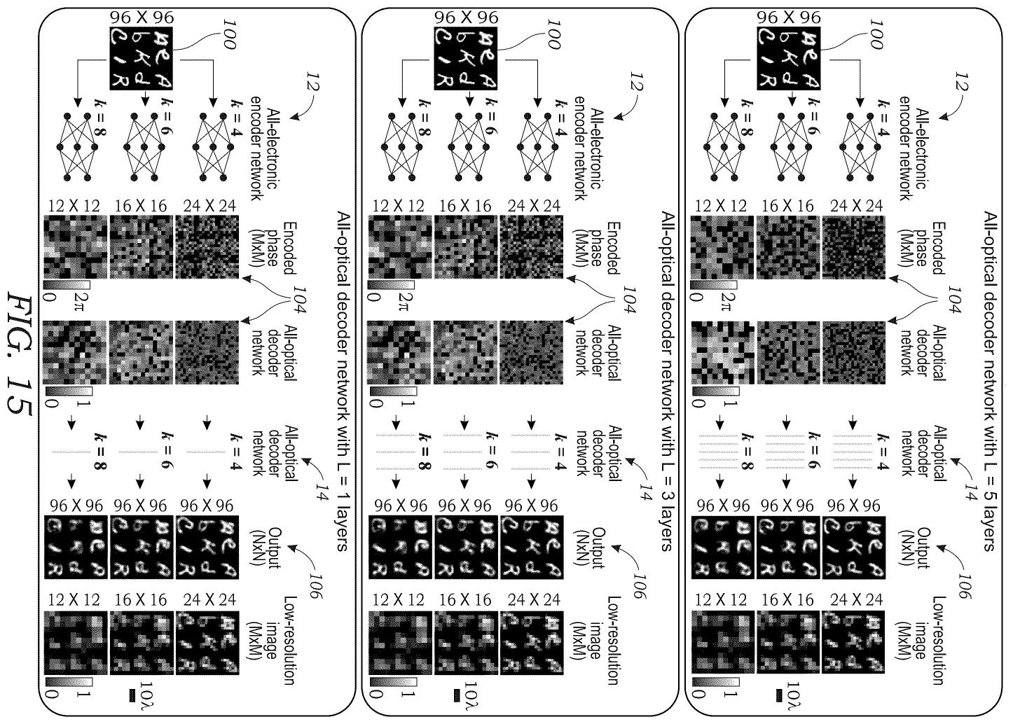

The experimental results of the diffractive SR image display system 10 with L=3 layers are shown in FIG. 11, clearly demonstrating the super-resolution capability of the all-optical diffractive decoder network 14 at its output FOV, also providing a very good match between the numerical forward model results and the experimental measurements. Similarly, FIG. 13 reports the success of the experimental results obtained using the SR image display system 10 with a single substrate layer 28 (L=1), also achieving super-resolution at the output of the all-optical diffractive decoder network 14. Despite using a single diffractive/substrate layer 18 in the all-optical diffractive decoder network 14, the jointly-trained encoding-decoding framework optically synthesized the target test letters at the output FOV. In these experiments, the average PSNR values achieved by the diffractive decoders are 13.134±1.368 dB for L=3 and 12.151±2.138 dB for L=1. These results are in line with the former analysis reported in FIGS. 7-9, confirming the advantages of deeper all-optical diffractive decoder networks 14 for better image synthesis at the output FOV.

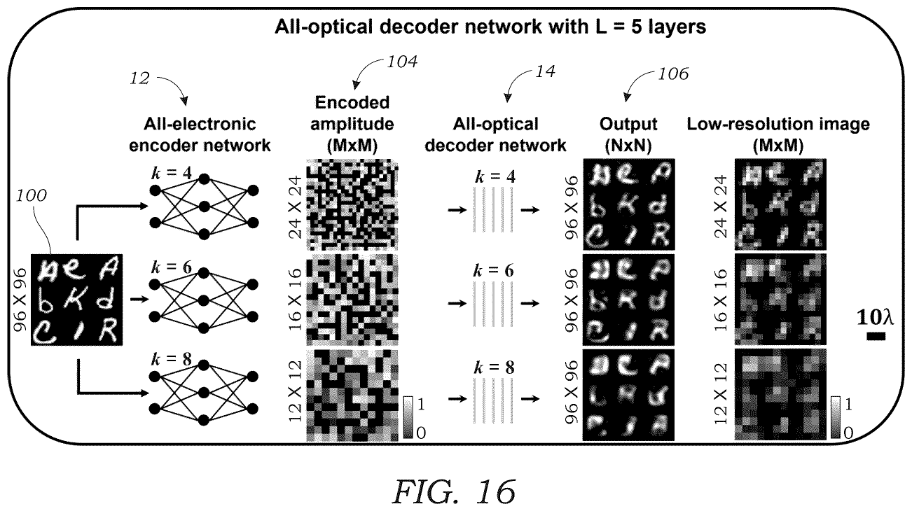

Finally, the resilience of the SR image display system 10 to different quantization levels of the wavefront modulation is illustrated in FIG. 14. For this analysis, the diffractive SR image display system 10 with L=5 substrate layers 18 trained for 16-bit quantization of phase-only wavefront modulator was blindly tested for lower quantization levels at 8-, 6-, 4-, and 2-bit. FIG. 14 shows that the presented diffractive SR image display system 10 can successfully synthesize super-resolved reconstructed or projection images 106 at its output even for 6-bit quantization of the encoded phase profiles. The overall image synthesis performance of the 8-bit (18.58 dB PSNR and 0.58 SSIM) and 6-bit (18.20 dB PSNR and 0.55 SSIM) quantization of the phase modulator/encoder demonstrates the robustness of the diffractive system 10, considering that there is 18.61 dB PSNR and 0.58 SSIM for the 16-bit phase quantization case. The diffractive SR image display system 10 fails to synthesize clear images at its output FOV for 2-bit phase quantization and is partially successful for 4-bit phase quantization (FIG. 14). For these lower bit-depth phase quantization cases, the presented encoding-decoding framework can be trained from scratch to further improve the image projection performance under limited phase encoding precision.

### DISCUSSION

A diffractive SR image display system 10 is disclosed that is based on a jointly-trained pair of an electronic encoder network 12 and an all-optical diffractive decoder network 14 that collectively improve the SBP of the image projection system. The deep learning-designed diffractive display system 10 synthesizes and projects/reconstructs super-resolved images 106 at its output FOV by encoding each high-resolution image of interest 100 into low-resolution representations 104 with lower number of pixels per image. As a result of this, the all-optical decoding capability of the all-optical diffractive decoder network 14 not only improves the effective SBP of the image projection system 10 but also reduces the data transmission and storage needs since low-resolution image generators 16 such as wavefront modulators are used. The all-optical diffractive decoder network 14 is an all-optical diffractive system composed of passive structured substrate layers 18 and therefore does not consume computing power except for the illumination light. Similarly, the all-optically synthesized images 106 are computed at the speed of light propagation between the encoder SLM plane and the all-optical diffractive decoder network 14 output FOV, and therefore the only computational bottleneck for speed and power consumption is at the inference of the front-end CNN encoder 12.

As shown in the experimental results (FIGS. 11 and 13), there are some relatively small discrepancies between the numerical output images of the forward model and the corresponding experimentally measured output images 106. There are potential error sources that might cause these discrepancies. First, the numerical forward model used in the training assumes a uniform plane wave incident on the surface of the wavefront modulator 16, and this assumption could potentially be violated in the experimental setup due to wavefront distortions of the THz source used. Additional errors might have occurred during the fabrication of each diffractive/substrate layer 18 due to the limited resolution of the 3D printer used to make the diffractive/substrate layers 18. Furthermore, any inaccuracy in the characterization of the refractive index of the 3D printing material at the illumination wavelength is yet another factor that might also be partly responsible for the small mismatch between the numerical and experimental results.

Although the THz part of the electromagnetic spectrum was used for these proof-of-concept experimental demonstrations, the main design principles and conclusions provided in herein also apply to display systems 10 operating at visible wavelengths. Extending the SR display system 10 designs to visible wavelengths is feasible using various nano-fabrication techniques providing subwavelength features, e.g., two-photon polymerization and lithography. Furthermore, the capabilities of the jointly-trained encoder and decoder networks 12, 14 in synthesizing SR images 106 at a small axial distance (˜150-350λ) from the wavefront modulation plane of the encoder 12 was investigated. The training procedures and design principles can also be extended for synthesizing 3D super-resolved object fields covering an extended working distance at the output of the all-optical diffractive decoder network 14.

While the SR image display system 10 results described herein were obtained at a single illumination wavelength, one can also extend the design principles of all-optical diffractive decoder networks 14 to operate at multiple wavelengths to bring spectral information into the projected images 106. The high-resolution image projections 106 at the output field-of-view may exhibit color information of the corresponding input images 100. To optically synthesize full-color (RGB) images, some of the traditional holographic display systems use sequential operation (i.e., one illumination wavelength at a given time followed by another wavelength), which spatially utilizes all the pixels of the SLM for each wavelength at the expense of reducing the frame rate. Spatial multiplexing of the SLM pixels among different illumination wavelength channels constitutes an alternative option, although this approach further sacrifices the SBP of the display among different color channels, restricting the output image size and the resolution. By incorporating the dispersion characteristics and the refractive index information of the wavefront modulation medium (e.g., liquid-crystal) and the all-optical diffractive decoder network 14 material as part of the optical forward model of the design, the diffractive display systems 10 can be extended to synthesize super-resolved images at a group of illumination wavelengths. In this case, the jointly-trained encoder network 12 can be optimized to drive the SLM 16 at multiple wavelengths, either simultaneously or sequentially, based on the assumption made during the training process of the encoder-decoder pair. In either mode of operation, multi-wavelength SR image displays using all-optical diffractive decoder networks 14 need more diffractive features/neurons for a given output FOV and SR factor compared to their monochrome versions to be able to handle independent spatial features at different illumination wavelengths or color channels of the input image 100.

The SR image display system 10 can be thought of as a hybrid autoencoder framework containing a digital encoder network 12 that is used to create low-dimensional representations 104 of the target high-resolution images 100 and an all-optical diffractive decoder network 14 (jointly-trained with the encoder network 12) to synthesize super-resolved images 106 at its output FOV from the diffraction patterns of these low-resolution encoded patterns 104 generated by the encoder network 12. This joint optimization and the communication between the electronic front-end and the diffractive optical back-end of the SR image display system 10 is crucial to increasing the SBP of the image formation models and will inspire the design of the new high-resolution camera and display systems that are compact, low-power, and computationally-efficient.

### Methods

all-Optical Decoder Design for SR Image Displays

In the optical forward model, the diffractive modulation layers (e.g., substrate layers 28) are discretized over a regular 2D grid with a period of wₓ and w_{y} for the x- and y-axes, respectively. Each point in the grid, termed ‘diffractive neuron’, denotes the transmittance coefficient tₗ[m,n] of the smallest feature in each modulation layer. The field transmittance of a diffractive layer, l≥1, is defined as:

$${t}_{l} [ m , n ] = exp ( j \frac{2 π}{λ} ( τ ( λ ) - {n}_{a} ) {h}_{l} [ m , n ] ) \qquad ( 1 )$$

where τ(λ)=n(λ)+jκ(λ) is the complex refractive index of the optical material used to fabricate the diffractive layers, λ denotes the wavelength of the coherent illumination. nₐ=1 refers to the refractive index of the medium (air in this case) surrounding the modulation layers, and hₗ[m,n] represents the material thickness of the corresponding neuron, which is defined as

$${h}_{l} [ m , n ] = \frac{tanh ( {o}_{l} [ m , n ] ) + 1}{2} ( {h}_{m} - {h}_{b} ) + {h}_{b} \qquad ( 2 )$$

where oₗ[m,n] is an auxiliary input variable used to compute the material thickness values between [h_{b}, hₘ]. These auxiliary variables oₗ[m,n] and the material thickness values hₗ[m,n] for all m, n & l are optimized using stochastic gradient descent-based error backpropagation and deep learning.

The 2D modulation function Tₗ(x,y) for continuous coordinates (x,y) can be written in terms of transmittance coefficients tₗ[m,n] and 2D rectangular sampling kernels pₗ(x,y) as follows:

$${T}_{l} ( x , y ) = {\sum }_{m} {\sum }_{n} {t}_{l} [ m , n ] {p}_{l} ( x - {mw}_{x} , y - {nw}_{y} ) \qquad ( 3 )$$

where pₗ(x,y) is defined as

$${p}_{l} ( x , y ) = \{ \begin{matrix}1 , & \vert x \vert < \frac{{w}_{x}}{2} \& \vert y \vert < \frac{{w}_{y}}{2} \\ 0 , & otherwise\end{matrix} \qquad ( 4 )$$

The light propagation between successive diffractive layers is modeled by a fast Fourier transform (FFT)-based implementation of the Rayleigh-Sommerfeld diffraction integral, using the angular spectrum method. This diffraction integral can be expressed as a 2D convolution of the propagation kernel w(x,y,z) and the input wavefield U′(x,y):

$${U}_{l + 1} ( x , y ) = {U}_{l}^{′} ( x , y ) * w ( x , y , {z}_{l + 1} - {z}_{l} ) , \qquad ( 5 )$$

$${U}_{l}^{′} ( x , y ) = {U}_{l} ( x , y ) {T}_{l} ( x , y ) ,$$

$$w ( x , y , z ) = \frac{z}{{r}^{2}} ( \frac{1}{2 π r} + \frac{1}{j λ} ) exp ( j \frac{2 π r}{λ} ) ,$$

$$r = \sqrt{{x}^{2} + {y}^{2} + {z}^{2}} .$$

### Diffractive Decoder Vaccination

To mitigate the impact of potential misalignments during the experiments, possible physical error sources were incorporated as part of the optical forward model of the all-optical diffractive decoder networks 14. During the training of the experimentally-tested diffractive designs, these errors were modeled using random 3D displacement vectors, D^{l}=(Dₓ, D_{y}, D_{z}) denoting the deviation of the location of diffractive layer l, from its ideal position, where Dₓ, D_{y}, and D_{z} were defined as uniformly distributed independent random variables,

$${D}_{x} ∼ U ( - {Δ}_{x} , {Δ}_{x} ) , \qquad ( 6 )$$

$${D}_{y} ∼ U ( - {Δ}_{y} , {Δ}_{y} ) ,$$

$${D}_{z} ∼ U ( - {Δ}_{z} , {Δ}_{z} ) .$$

The variables Δₓ, Δ_{y}, and Δ_{z} in Eq. 6 denote the maximum amount of displacement along the corresponding axis. Accordingly, the position of the diffractive layer l at i^{th} iteration L^{(l,i)} was defined as

$${L}^{( l , i )} = ( {L}_{x}^{l} , {L}_{y}^{l} , , {L}_{z}^{l} , ) + ( {D}_{x}^{( l , i )} , {D}_{y}^{( l , i )} , {D}_{z}^{( l , i )} ) . \qquad ( 7 )$$

### Encoder CNN Network Design for SR Image Displays

A CNN-based electronic encoder network 12 was used to compress high-resolution input images of interest into lower-dimensional latent representations 104 that can be presented using a low SBP wavefront modulator or SLM 16. The CNN network architecture is illustrated in FIG. 6A. It contains four (4) convolutional blocks, followed by a flattening operation, a fully connected layer, a rectified linear unit (ReLU) based activation function, and an unflattening operation. Each convolutional block contains three (3) pairs of 4×4 convolutional filters (“same” padding configuration) with a Leaky ReLU (with a slope of α=0.1). For the i^{th} convolutional block, there are 2¹⁺ⁱ channels. To decrease the dimensions of the channels and obtain low-dimensional representations at the output of the electronic encoder CNN, a fully connected layer is utilized at the end.

### Training and Test Dataset Preparation

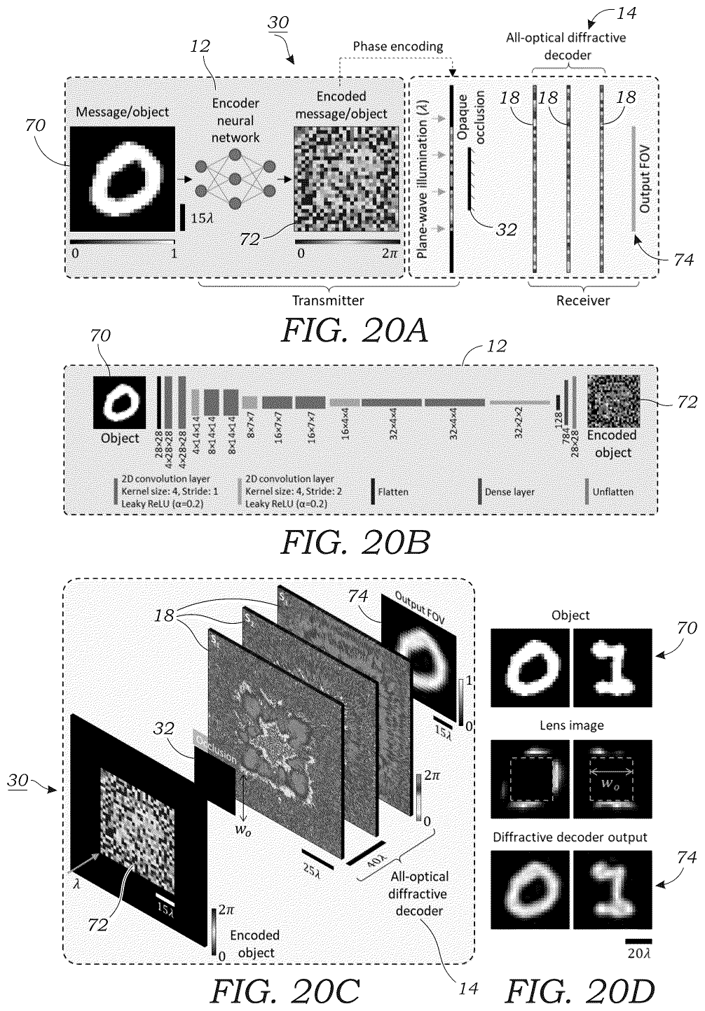

A training image dataset was created, namely the EMNIST display dataset, to train and test the diffractive SR display system 10. As seen in FIG. 18, each image in this display dataset was generated by using different numbers of images selected from the EMNIST handwritten letters. The selected letters were augmented by predefined geometrical operations including scaling (K˜U(0.84, 1)), rotation (Θ˜U(−5, °5°)), and translation (Dₓ, D_{y}˜U(−1.06λ, 1.06λ). Then, these selected and augmented images were randomly placed in a 3×3 grid. This procedure was used for each image in the display dataset. In the original EMNIST handwritten letters dataset, there are 88,000 and 14,800 letter images for training and testing, respectively. The original size of these letters is 28×28 pixels. Before applying the tiling procedure described above, each image was interpolated to 32×32 using bicubic interpolation. For the training dataset, 60,000 images (96×96 pixels) containing 1, 2, 3, and 4 different handwritten letters (15,000 images for each case) were created using the EMNIST letters training dataset. For the validation dataset, 6,000 images (96×96 pixels) containing 1, 2, 3, and 4 different handwritten letters (1,500 images for each case) were created using the EMNIST letters training dataset. For the test dataset, 6,000 images (96×96 pixels) containing 6, 7, 8, and 9 handwritten letters (1,500 images for each case) were created using the EMNIST letters test dataset.

In the experimentally tested designs, two complementary image sets containing 80,000 and 8,800 different handwritten letters from the EMNIST letters training dataset were used as the training and validation datasets, respectively. The EMNIST letters test dataset with 14,800 different handwritten letters was used as the test dataset. The handwritten letters were resized to 15×15 pixels using bicubic downsampling (with an anti-aliasing filter), based on the effective pixel size used at the measurement (output) plane.

### Implementation Details of the Numerically-Tested Diffractive SR Display Systems

Diffractive neuron width of the transmissive layers (wₓ, w_{y}) and the sampling period of the light propagation model were chosen as 0.533λ. Each diffractive layer had a size of 106.66λ×106.66λ (200×200 pixels). The input and output FOVs of the diffractive decoders were 51.168λ×51.168λ (96×96 pixels). To avoid aliasing in the optical forward model, these matrices were padded with zeros to have 400×400 pixels. In the optical forward propagation model, the material absorption was assumed to be zero (κ(λ)=0). Therefore, the transmittance coefficient of each feature of a diffractive layer can be written as:

$${t}_{l} [ m , n ] = exp ( j {θ}_{l} [ m , n ] ) = exp ( j \frac{2 π}{λ} ( n ( λ ) - {n}_{a} ) {h}_{l} [ m , n ] ) . \qquad ( 8 )$$

Phase coefficients θₗ[m,n] of each diffractive layer of the decoder was optimized using deep learning and error backpropagation. The phase coefficients θₗ[m,n] were initialized as 0.

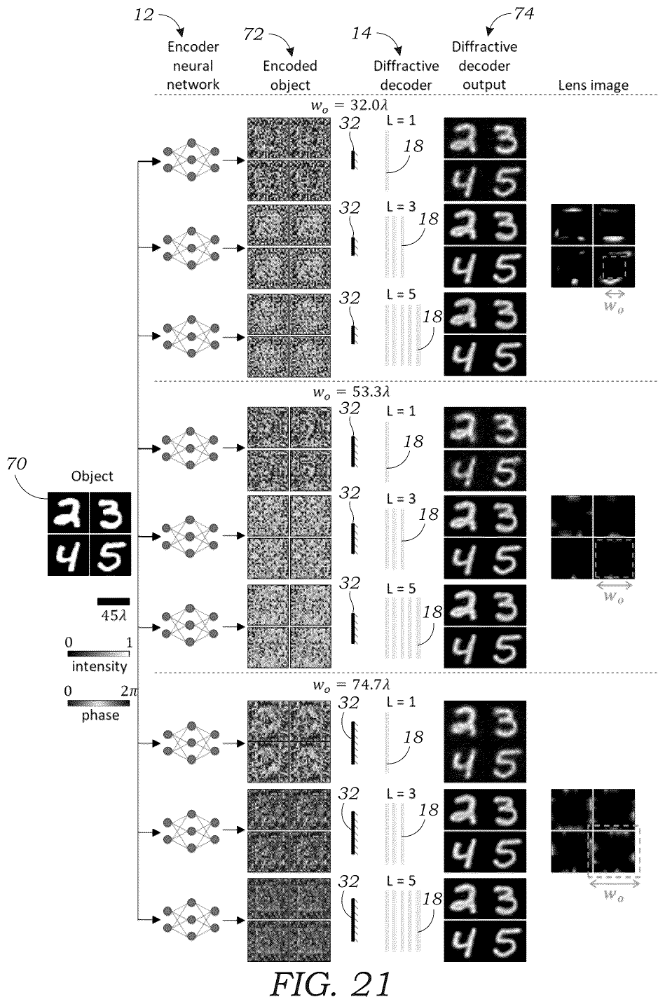

Different all-optical diffractive decoder networks 14, including 1, 3, and 5 transmissive layers (substrate layers 18) were analyzed in the results. The axial distances (FIG. 6B) from the input plane to the first diffractive layer d₁, from one diffractive layer to another diffractive layer d₂, and from the last layer to the output plane d₃ were optimized empirically (see Table 1). The trained phase profiles of the transmissive layers of the diffractive decoders using phase-only SLMs are reported in FIG. 19.

TABLE 1
Table 1. Axial distances for different diffractive
decoder designs including 1, 3, and 5 diffractive
layers used in the numerical and experimental results

| | | d₁ | d₂ | d₃ |
|---|---|---|---|---|
| Numerical | 1 layer | 6.667λ | — | 173.333λ |
| results | 3 layers | 4λ | 53.334λ | 53.334λ |
| | 5 layers | 2.667λ | 66.667λ | 80λ |
| Experimental | 1 layer | 26.667λ | — | 173.333λ |
| results | 3 layers | 26.667λ | 53.334λ | 53.334λ |

### Implementation Details of the Experimentally-Tested Diffractive SR Display Systems

In the experiments, a monochromatic THz illumination source (λ=˜0.75 mm) was used. The diffractive neuron size of the substrate layers 18 and the sampling period of the light propagation model were chosen as ˜0.667λ and the size of each layer 18 was determined to be 66.7λ×66.7λ (5 cm×5 cm). The effective pixel size at the measurement plane was selected as ˜2.67λ in the experiments. The size of the phase-only wavefront modulator 16 was selected as 40λ×40λ (3 cm×3 cm), which is also equal to the size of the output FOV. Based on the ˜2.67λ pixel size at the output FOV, the number of the output image pixels was set to be 15×15 and the LR wavefront modulator 16 was selected as a 5×5 pixel phase-only layer with a pixel pitch of 8λ×8λ. This corresponds to a desired SR factor of k=15/5=3 that was targeted during the training of these models i.e., a 9-fold SBP enhancement through the all-optical diffractive decoder network 14. To avoid spatial aliasing in the optical forward model, the matrices were padded with zeros to have 300×300 pixels.

The complex refractive index of the 3D-printing material τ(λ) used to fabricate the substrate layers 18 and the phase-encoded inputs was measured as ˜1.6518+j0.0612. In the model, the material thickness of each diffractive neuron hₗ[m,n] was optimized in the range of [0.5 mm, ˜1.64 mm] that corresponds to [−π, π] for phase modulation. The phase coefficients θₗ[m,n] were initialized as 0.

Two all-optical decoder networks 14 with L=3 and L=1 were fabricated and tested in the experiments. The axial distances for these models are given in Table 1. As part of the all-optical diffractive decoder network vaccination process, independent random alignment errors along the axial and lateral coordinates were added to the positions of the substrate layers 18 and the input FOV during the training phase, as detailed in Eq. (7). During the training of these experimentally tested models, Δₓ, Δ_{y}, and Δ_{z} were set to be ˜0.334λ, ˜0.334λ, and ˜0.533λ, respectively. The optimized thickness maps for the resulting substrate layers 18 and the phase-only encoded representations were converted into STL files using MATLAB and they were fabricated by using a 3D printer (Objet30 Pro, Stratasys Ltd.).

### Experimental Setup

The schematic diagram of the experimental setup is shown in FIGS. 10C-10D. The THz plane wave incident on the object was generated through a WR2.2 modular amplifier/multiplier chain (AMC) 50 with a compatible diagonal horn antenna 58 (Virginia Diode Inc.). The AMC 50 received a 10 dBm RF input signal at 11.111 GHZ (ƒ_{RF1}) via RF synthesizer 52 and multiplied it 36 times to generate a continuous-wave (CW) radiation at 0.4 THz. The AMC output was modulated at a 1 kHz rate via signal generator 56 to resolve low-noise output data through lock-in detection at the lock-in amplifier 54. The exit aperture of the horn antenna 58 was placed ˜60 cm away from the object plane of the 3D-printed all-optical decoder network 14. The diffracted THz radiation at the output plane was detected with a single-pixel Mixer/AMC (Virginia Diode Inc.) 60. A 10 dBm RF signal at 11.083 GHZ (ƒ_{RF2}) was fed to the detector as a local oscillator for mixing, to down-convert the detected signal to 1 GHz. The detector was placed on an X-Y positioning stage, including two linear motorized stages (Thorlabs NRT100). The output FOV was scanned using a 0.5×0.25 mm detector with a step size of 1 mm. A 2×2-pixel binning was used to increase the SNR and approximately match the output pixel size of the design, i.e., ˜2.67λ. The down-converted signal was sent to cascaded low-noise amplifiers 64 (Mini-Circuits ZRL-1150-LN+) to obtain a 40 dB amplification. Then, a 1 GHZ (+/−10 MHz) bandpass filter 66 (KL Electronics 3C40-1000/T10-O/O) was used to eliminate the noise coming from unwanted frequency bands. The amplified and filtered signal passed through a tunable attenuator 68 (HP 8495B) for linear calibration and a low-noise power detector 70 (Mini-Circuits ZX47-60). The output voltage signal was read by a lock-in amplifier 54 (Stanford Research SR830). The modulation signal using signal generator 56 was used as the reference signal for the lock-in amplifier 54. According to the calibration results, the lock-in amplifier readings were converted to a linear scale. The bottom 5% and the top 5% of all the pixel values of each measurement were saturated and the remaining pixel values were mapped to a dynamic range between 0 and 1.

### Training Loss Function and Performance Comparison Metrics

For the joint training of the electronic CNN-based encoder network 12 and the all-optical diffractive decoder network 14, the mean absolute error function together with an efficiency penalty term (e^{-η}) was used as the training loss function ( [symbol] ), which is defined as:

$$ℒ = \frac{1}{N} {\sum }_{i = 1}^{N} \vert {y}_{i} - σ {\hat{y}}_{i} \vert + γ {e}^{- η} , \qquad ( 9 )$$

$$σ = \frac{{\sum }_{i = 1}^{N} {y}_{i}}{{\sum }_{i = 1}^{N} {\hat{y}}_{i}} ,$$

$$η = 10 \; 0 \times \frac{{P}_{o}}{{P}_{i}} .$$

where yᵢ and ŷᵢ denote the target (ground truth) high-resolution image and the all-optical decoder network output intensity, respectively. N represents the number of pixels in each image, and σ is a normalization term. Pᵢ and

$${P}_{o} = {\sum }_{i = 1}^{N} {\hat{y}}_{i}$$

represent the optical power incident on the input FOV and the output FOV, respectively. The power efficiency of an all-optical diffractive decoder network 14 can be adjusted by tuning γ. For the training of the experimentally demonstrated all-optical diffractive decoder network 14, γ was set to be 0.005 for L=1 and 0.015 for L=3; for the other designs, γ=0.

During the joint training of the CNN encoder 12 and the all-optical diffractive decoder network 14, several image data augmentations, including random image rotations (0, 90, 180, and 270 degrees), random flipping of images, and random contrast adjustments were used. The joint training was implemented in Python (v3.6.12) and TensorFlow (v1.15.4, Google LLC). Adam optimizer was used during the training with a learning rate of 0.001 for the all-optical diffractive decoders 14 and 0.0005 for the CNN-based encoders 12. All the networks 12, 14 were trained using a Geforce RTX 3090 GPU (Nvidia Corp.) and an AMD Ryzen Threadripper 3960X CPU (Advanced Micro Devices Inc.) with 264 GB of RAM. Each network 12, 14 was trained for at most 17 hours (500 epochs) with a batch size of 40.

For quantitative comparison of the results, PSNR and SSIM values were calculated for each target image in the test sets. PSNR is computed as follows

$$PSNR = 10 {log}_{10} ( \frac{1}{\frac{1}{N} {\sum }_{i = 1}^{N} {\vert {y}_{i} - σ {\hat{y}}_{i} \vert}^{2}} ) . \qquad ( 10 )$$

SSIM is computed using the standard implementation in TensorFlow with a maximum value of 1. For visual comparison, the low-resolution versions of the target images were obtained using k-fold downsampling with a bicubic kernel (and an anti-aliasing filter).

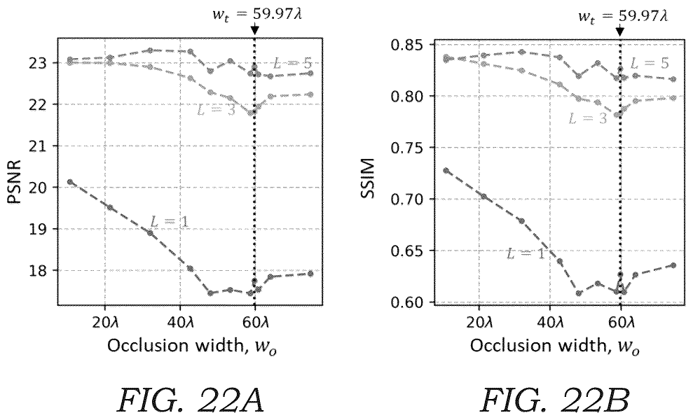

FIG. 20A illustrates another embodiment a communication system 30 that includes an electronic encoder network 12 and an all-optical decoder network 14 that is able to transmit a message or signal 70 in space from the electronic encoder network 12 to the all-optical decoder network 14 despite the optical path being at least partially occluded with an opaque occlusion and/or a diffusive medium 32. Here, the occlusion and/or diffusive medium 32 is located between the electronic encoder network 12 and the all-optical decoder network 14 yet the message or signal 70 (which may include image(s) in some embodiments) can still be resolved by the all-optical decoder network 14. The electronic encoder network 12 is used to create an encoded message or wavefront 72 that is transmitted over free space to the all-optical decoder network 14 which generates a decoded output 74 that contains the transmitted message or signal 70. In this method, an electronic encoder network 12 and the all-optical decoder network 14 are jointly trained using deep learning to transfer the optical message or signal 70 of interest around the opaque occlusion/diffusive medium 32 of an arbitrary shape. The all-optical decoder network 14 includes successive spatially-engineered passive surfaces (i.e., substrate layers 18) that process optical information through light-matter interactions. Following its training, the encoder-decoder pair can communicate any arbitrary optical information or signal around opaque occlusions or diffusive media 32, where information decoding occurs at the speed of light propagation. For occlusions or diffusive media 32 that change their size and/or shape and/or properties as a function of time, the electronic encoder network 12 can be retrained to successfully communicate with the existing all-optical decoder network 14, without changing the physical substrate layer(s) 18 already deployed. This system 30 was validated experimentally in the terahertz spectrum using a 3D-printed all-optical decoder network 14 to communicate around a fully opaque occlusion. Scalable for operation in any wavelength regime, this scheme could be particularly useful in emerging high data-rate free-space communication systems.

In this embodiment, an electronic encoder network 12, trained in unison with an all-optical decoder network 14, encodes the message/signals 70 of interest (i.e., encoded message) in the encoded wavefront 72 to effectively bypass the opaque occlusion and/or diffusive medium 32 and be decoded at the receiver by an all-optical decoder network 14, using passive diffraction through thin structured substrate layers 18. This all-optical decoding is performed on the encoded wavefront 72 that carries the optical message/signal 70 of interest, after its obstruction by an arbitrarily shaped opaque occlusion 32. The all-optical decoder network 14 processes the secondary waves scattered through the edges of the opaque occlusion 32 using a passive, smart material comprised of successive spatially engineered surfaces, and performs the reconstruction of the hidden information to generate the decoded output 74 at the speed of light propagation through a thin diffractive volume that axially spans <100×λ, where λ is the wavelength of the illumination light.

The combination of electronic encoding and all-optical decoding is capable of direct optical communication between the electronic encoder network 12 (i.e., transmitter) and the all-optical decoder network 14 (i.e., receiver) even when the opaque occlusion body 32 entirely blocks the transmitter's field-of-view (FOV). This system 30 can be configured to be highly power efficient, reaching diffraction efficiencies of >50% at its output. In the case of opaque occlusions of diffusive media 32 that change their size/shape and/or properties over time, the electronic encoder network 12 can be retrained to successfully communicate with an existing all-optical decoder network 14, without changing its physical structure that is already deployed. This makes the presented system 30 highly dynamic and easy to adapt to external and uncontrolled changes that might happen between the transmitter and receiver apertures. The system 30 can be extended for operation at different parts of the electromagnetic spectrum, and finds applications in emerging high-data-rate free-space communication technologies, under scenarios where different undesired structures occlude the direct channel of communication between the transmitter and the receiver.

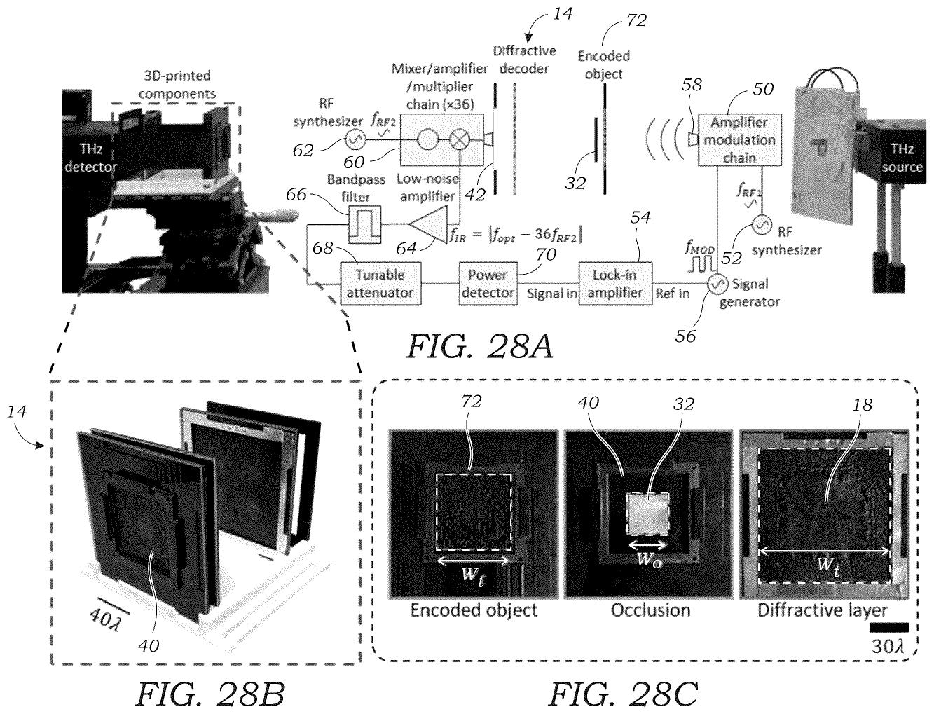

A schematic depicting the optical communication system 30 that is able to transmit around an opaque occlusion 32 with zero light transmittance is shown in FIG. 20A. The message or signal 70 to be transmitted, e.g., the image of an object, is fed to an electronic encoder neural network 12, which outputs a phase-encoded optical representation 72 of the message. It should be appreciated that in other embodiments the representation of the message may be amplitude-only encoded or complex-value encoded. This code is imparted onto the phase of a plane-wave illumination, which is transmitted toward the all-optical decoder network 14. In the experimental setup, the plane-wave illumination passed through an aperture 40 (FIGS. 28B, 28C) that is partially or entirely blocked by an opaque occlusion 32. The scattered waves from the edges of the opaque occlusion 32 travel toward the receiver aperture 42 (FIG. 28A) as secondary waves, where an all-optical decoder network 14 all-optically decodes the received light to directly reproduce the message/object 70 at its output FOV. This decoding operation is completed as the light propagates through the thin decoder substrate layers 18. The light may also reflect off the substrate layer(s) 18 in embodiments that include one or more reflective substrate layers 18. For this collaborative encoding-decoding scheme, the electronic encoder network 12 and the all-optical decoder network 14 are jointly digitally trained in a data-driven manner for effective optical communication, bypassing the fully opaque occlusion positioned between the transmitter aperture and the receiver.

FIGS. 20B and 20C provide a deeper look into the respective architectures of the electronic encoder network 12 and the all-optical decoder network 14 that was created. As shown in FIG. 20B, the convolutional neural network (CNN)-based electronic encoder network 12 is composed of several convolution layers, followed by a dense layer representing the encoded output. This dense layer output is rearranged into a 2D-array corresponding to the spatial grid that maps the phase-encoded transmitter aperture. It was assumed that both the desired messages and the phase codes to be transmitted comprise 28×28 pixels unless otherwise stated. The architecture of the electronic encoder network 12 remains the same across all the designs reported herein. The architecture of the all-optical decoder network 14, which decodes the transmitted and obstructed phase-encoded waves, is shown in FIG. 20C. FIG. 20C shows an all-optical decoder network 14 that includes L=3 spatially-engineered substrate layers 18 (i.e., S₁, S₂ and S₃). However, also reported herein are results for designs that include all-optical decoder networks 14 with L=1 and L=5 substrate layers 18, used for comparison. Together with the encoder CNN parameters, the spatial features of the diffractive surfaces (i.e., substrate layers 18) of the all-optical decoder network 14 are optimized to decode the encoded and blocked/obscured wavefront and generate a decoded output 74. In the tested embodiment, phase-only diffractive features 20 were considered, i.e., only the phase values of the features 20 at each diffractive surface are trainable (see the ‘Materials and Methods’ section for details). FIG. 20D also compares the performance of the presented electronic encoding and diffractive decoding system 30 to that of a lens-based camera. As shown in FIG. 20D, in contrast to the decoded output 74, the lens images reveal significant loss of information caused by the opaque occlusion 32 in a standard camera system, showcasing the scale of the problem that is addressed through this embodiment.

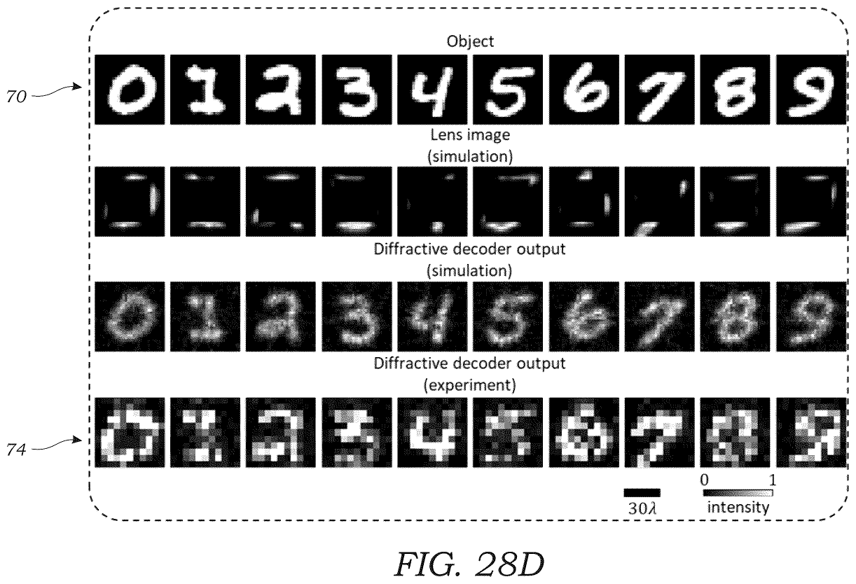

For all the models reported herein, the data-driven joint digital training of the CNN-based electronic encoder network 12 and the all-optical decoder network 14 was accomplished by minimizing a structural loss function defined between the object (ground-truth message) and the all-optical decoder network output, using 55,000 images of handwritten digits from the MNIST training dataset, augmented by 55,000 additional custom-generated images examples of which are illustrated in FIG. 29. All the results come from blind testing with objects/messages never used during training. The digital training involves training the encoder network 12 and digital model of the all-optical decoder network 14 to create the design parameters for the substrate layers 18 used to make the physical embodiment of the optimized all-optical decoder network 14.

### Numerical Analysis of Diffractive Optical Communication Around Opaque Occlusions

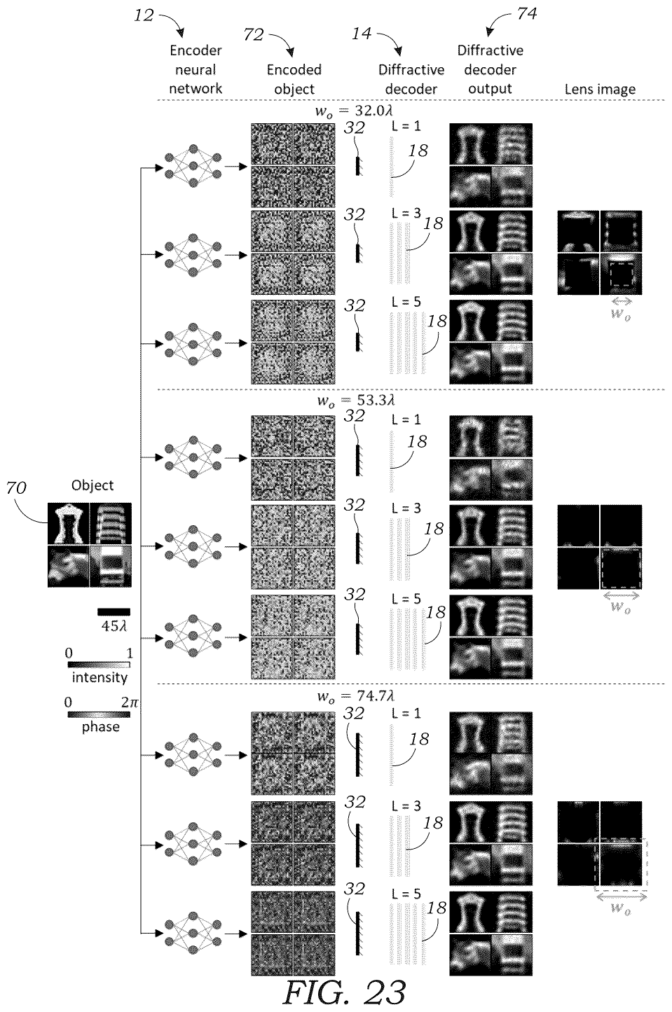

First, the performance of trained encoder-decoder pairs with different diffractive decoder architectures in terms of the number of diffractive surfaces (i.e., substrate layers 18) employed are compared for various levels of opaque occlusions 32. Specifically, for each of the occlusion width values, i.e., wₒ=32.0λ, wₒ=53.3λ and wₒ=74.7λ, three encoder-decoder pairs were designed, with L=1. L=3, and L=5 diffractive substrate layers 18 within the all-optical decoder networks 14, and compared the performance of these designs for new handwritten digits in FIG. 21. This blind testing refers to ‘internal generalization’ because even though these particular test objects were never used in training, they are from the same dataset. As shown In FIG. 21, even L=1 designs can faithfully decode the message 70 for optical communication around these various levels of occlusions. Furthermore, as the number of layers 18 in the all-optical decoder network 14 increases to L=3 or L=5, the quality of the output also gets better. While the performance of the L=1 design deteriorates slightly as wₒ increases, the L=3 and L=5 designs do not show any appreciable degradation in qualitative performance for such bigger occlusions. Note that the width of the transmitter aperture is wₜ=59.73λ; therefore, for an occlusion size of for wₒ=74.7λ, none of the ballistic photons can reach the receiver aperture since the opaque occlusion completely blocks the aperture of the encoding transmitter aperture. Nonetheless, the scattering from the occlusion edges suffices for the encoder-decoder pair to communicate faithfully. It should be appreciated that that apertures on the transmitter and receiver side of the experimental setup may not be needed to implement the communication system 30 and they may be omitted.

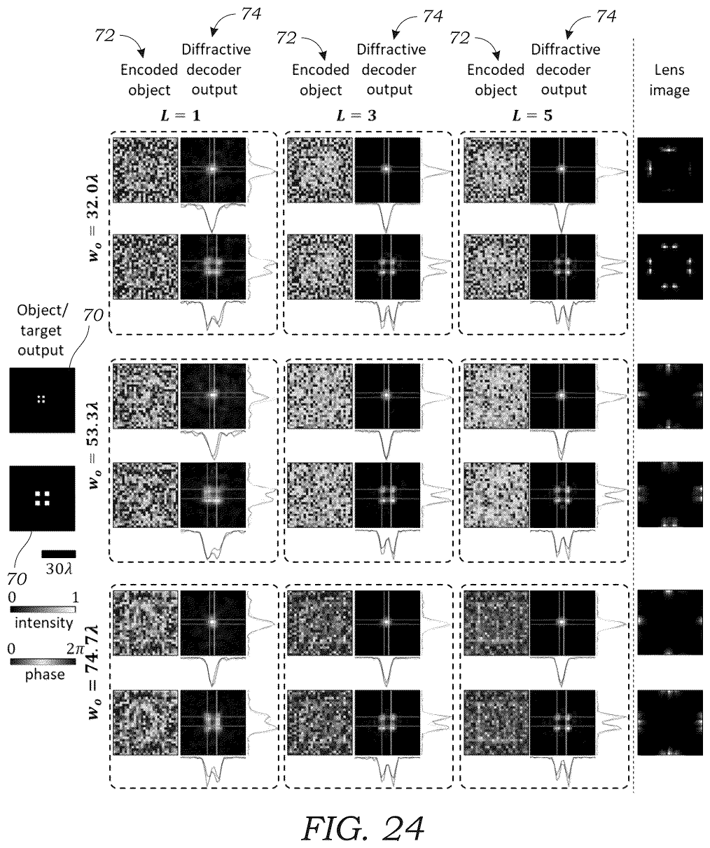

To supplement the qualitative results illustrated in FIG. 21, the performance of different encoder-decoder pairs designed for increasing occlusion widths (wₒ) was compared, in terms of peak signal-to-noise ratio (PSNR) and structural similarity index measure (SSIM) averaged over 10,000 handwritten digits from the MNIST test set (never used before); see FIGS. 22A-22B, respectively. With increasing wₒ, a larger decrease in the performance is seen in L=1 designs compared to L=3 and L=5 designs. Interestingly, there is a slight improvement in the performance of L=1 and L=3 decoders as wₒ surpasses wₜ=59.73λ (the transmitter aperture width); this improved level of performance is retained for wₒ>wₜ, the cause of which is discussed herein.

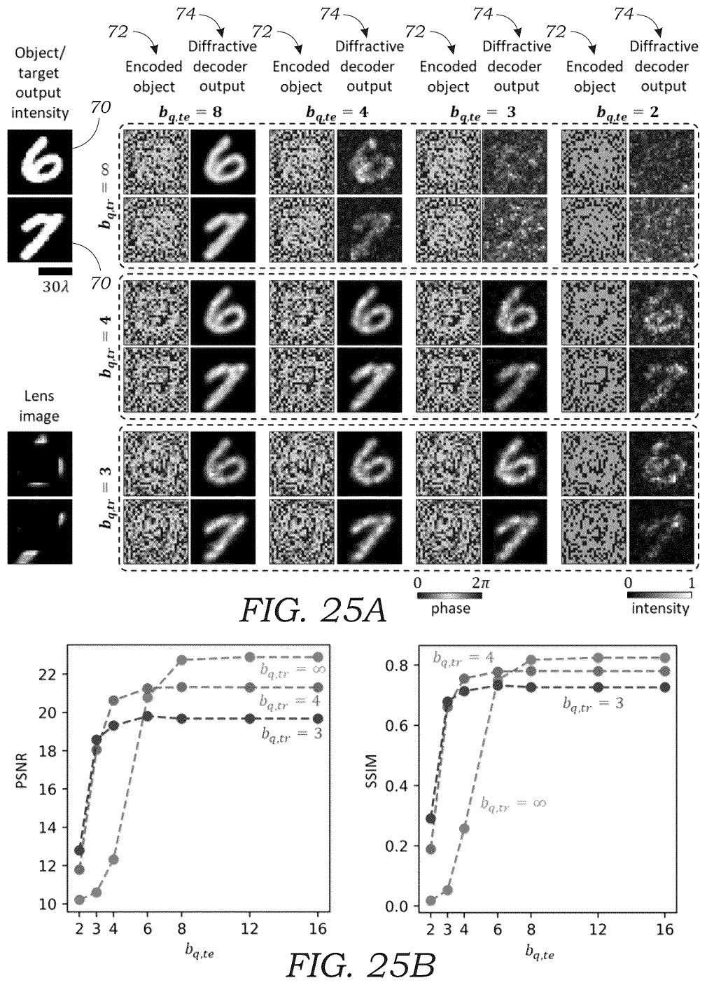

Next, for the same designs reported in FIG. 21, the external generalization of these encoder-decoder pairs was examined by testing their performance on types of objects that were not represented in the training set; see FIG. 23. For this analysis, two images of fashion products were randomly chosen from the Fashion-MNIST test set (top) and two additional images from the CIFAR-10 test set (bottom). As shown in FIG. 23, the encoder-decoder designs show excellent generalization to these completely different object types. Although the all-optical decoder network outputs of the L=1 decoder designs for wₒ=53.3λ and wₒ=74.7λ are slightly degraded, the objects are still recognizable at the output plane even for the complete blockage of the transmitter aperture by the occlusion.

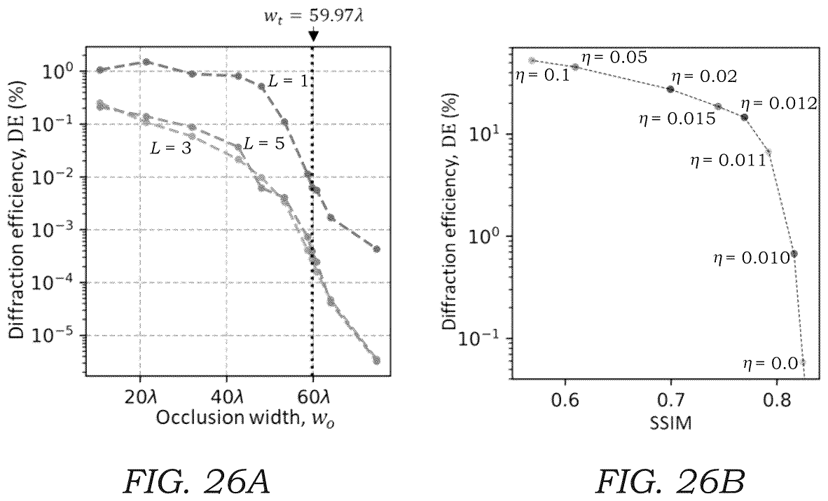

The ability of these designs to resolve closely separated features in their outputs was also investigated. For this purpose, test patterns consisting of four closely spaced dots were transmitted and the corresponding all-optical decoder network outputs are shown in FIG. 24. For the top (bottom) pattern, the vertical/horizontal separation between the inner edges of the dots is 2.12λ (4.24λ). None of the designs could resolve the dots separated by 2.12λ; however, the dots separated by 4.24λ were resolved by all the encoder-decoder designs with good contrast, as can be seen from the cross-sections accompanying the output images in FIG. 24. It is to be noted that this resolution limit of 4.24λ is due to the output pixel size, which was set as 2.12λ in the simulations. The effective resolution of the encoder-decoder communication system 30 can be further improved within the diffraction limit of light by using higher-resolution objects and a smaller pixel size during the training.

### Impact of Phase Bit Depth on Performance

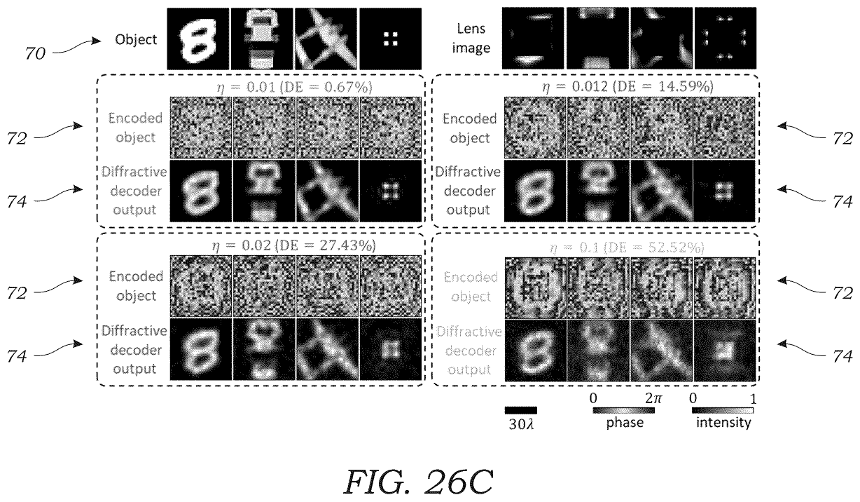

Here, the effect of a finite bit-depth b_{q} phase quantization of the encoder plane was studied. For the results presented so far, an infinite bit-depth of phase quantization was assumed. For the wₒ=32.0λ, L=3 design (trained assuming an infinite bit-depth b_{q,tr}=∞), the first row of FIG. 25A shows the impact of quantizing the encoded phase patterns as well as the diffractive layer phase values with a finite bit-depth b_{q,te}. This represents an “attack” on the design since the electronic encoder network 12 and the all-optical decoder network 14 were trained without such a phase bit-depth restriction; stated differently, they were trained with b_{q,tr}=∞ and are now tested with finite levels of b_{q,te}. For the b_{q,tr}=80 designs, the output quality remains unaffected for b_{q,te}=8; however, there is considerable degradation under b_{q,te}=4, and complete failure occurred with b_{q,te}=3 and b_{q,te}=2. However, this sharp performance degradation with decreasing b_{q,te} can be amended by considering the finite bit-depth during training. To showcase this, two additional designs were trained with wₒ=32.0λ and L=3 assuming finite bit-depths of b_{q,tr}=4 and b_{q,tr}=3; their blind testing performance with decreasing b_{q,te} is reported in the second and third rows of FIG. 25A, respectively. Both of these designs show robustness against bit-depth reduction up to b_{q,te}=3 (i.e., 8-level phase quantization at the encoder and decoder layers). However, even with b_{q,te}=2 (only 4-level phase quantization), the outputs are still recognizable as shown in FIG. 25A. The performance (PSNR and SSIM) of these three designs (b_{q,tr}=∞ b_{q,tr}=4, b_{q,tr}=3) was quantified for different bate levels; see FIG. 25B. These quantitative comparisons restate the same conclusion: training with a lower b_{q,tr} results in robust encoder-decoder designs that preserve their optical communication quality despite a reduction in the bit-depth b_{q,te}, albeit with a relatively small sacrifice in the output performance.

### Output Power Efficiency

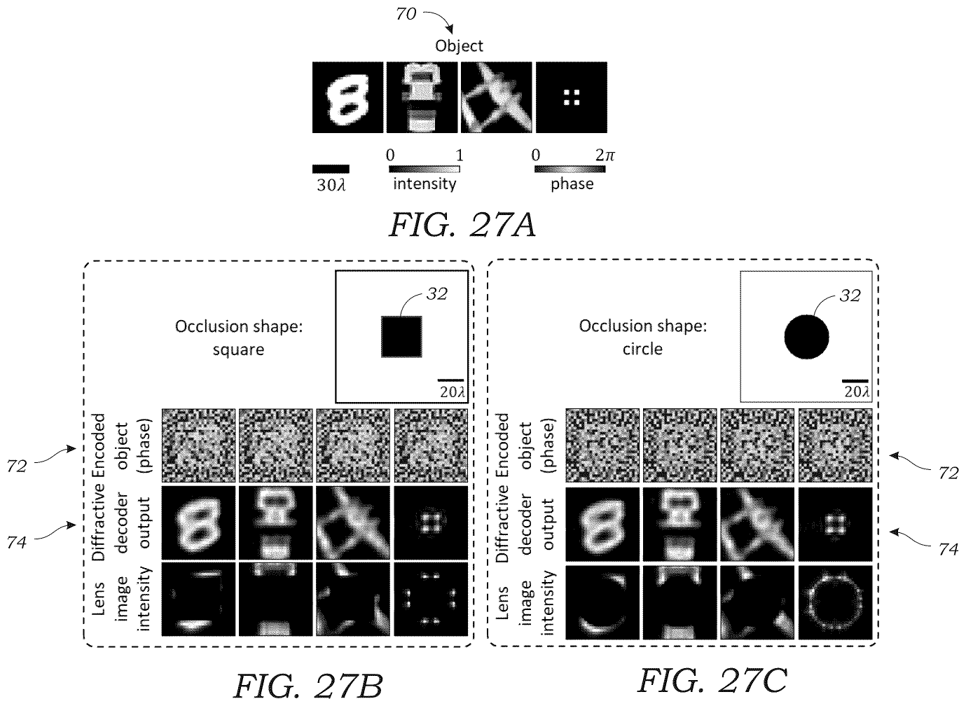

Next, the power efficiency of the optical communication system 30 was investigated around opaque occlusions 32 using jointly-trained electronic encoder-diffractive decoder pairs. For this analysis, the diffraction efficiency (DE) was defined as the ratio of the optical power at the output FOV to the optical power departing the transmitter aperture. In FIG. 26A, the diffraction efficiency of the same designs shown in FIGS. 22A-22B is plotted, as a function of the occlusion size. These values are calculated by averaging over 10,000 MNIST test images. These results reveal that the diffraction efficiency decreases monotonically with increasing occlusion width, as expected. Moreover, the diffraction efficiencies are relatively low, i.e., below or around 1%, even for small occlusions. However, this issue of low diffraction efficiency can be addressed in the design stage by adding to the training loss function an additional loss term that penalizes low diffraction efficiency (see the ‘Materials and Methods’ section, Eq. 1). FIG. 26B depicts the improvement of diffraction efficiency resulting from increasing the weight (η) of this additive loss term during the training stage. For example, the η=0.02 and η=0.1 designs yield an average diffraction efficiency of 27.43% and 52.52%, respectively, while still being able to resolve various features of the target images as shown in FIG. 26C. This additive loss weight η therefore provides a powerful mechanism for improving the output diffraction efficiency significantly with a relatively small sacrifice in the image quality as exemplified in FIGS. 26B-26C.

### Occlusion Shape

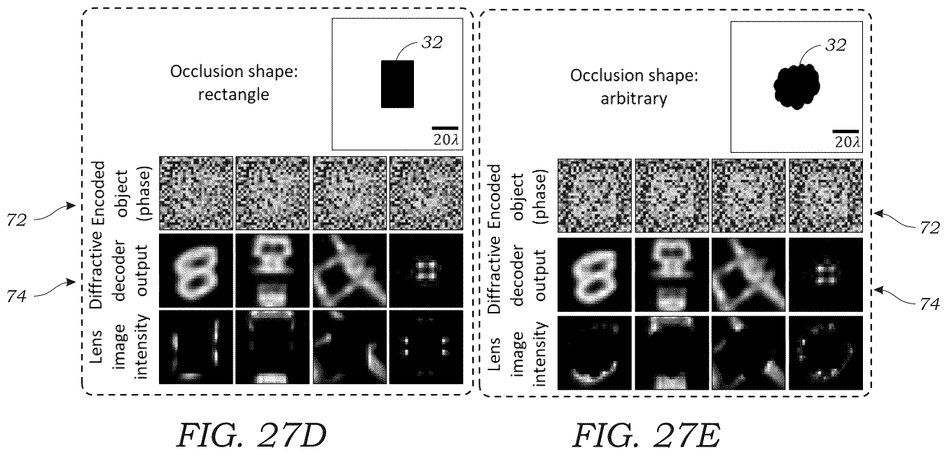

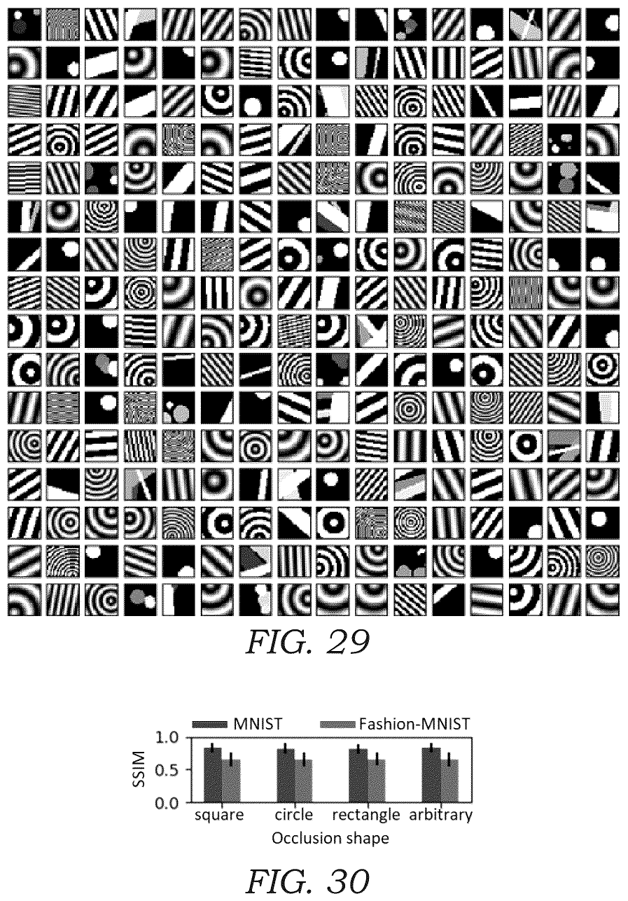

So far, square-shaped opaque occlusions 32 placed symmetrically around the optical axis have been considered. However, the communication system 30 is not limited to square-shaped occlusions and, in fact, can be used to communicate around any arbitrary occlusion shape. FIGS. 27A-27E show the performance comparison of four different trained encoder-decoder pairs for four different occlusion shapes, where the areas of the opaque occlusions 32 were kept approximately the same. One can see that the shape of the occlusion 32 does not have any perceptible effect on the output image quality. The average SSIM values calculated for these four models are plotted over 10,000 MNIST test images (internal generalization) as well as 10,000 Fashion-MNIST test images (external generalization) in FIG. 30, which further confirms the success of this embodiment for different opaque occlusion 32 structures, including randomly shaped occlusions as shown in FIG. 27E.

### Experimental Validation

The electronic encoding-diffractive decoding system 30 for communication around opaque occlusions 32 in the terahertz. (THz) part of the spectrum (λ=0.75 mm) was experimentally validated using a 3D-printed single-layer 18 (L=1) all-optical decoder network 14 (see the ‘Materials and Methods’ section for details). The setup used for this experimental validation is depicted in FIG. 28A. FIGS. 28B and 28C show the 3D printed components used to implement the encoded (phase) patterns, the opaque occlusion 32, and the diffractive decoder substrate layer 18. Shown in FIG. 28C, the width of the transmitter aperture (dashed square in “Encoded object” image) housing the encoded phase patterns was selected as wₜ≈59.73λ, whereas the width of the opaque occlusion (dashed square in “Occlusion” image) was wₒ≈32.0λ and the diffractive decoder layer (dashed square in “Diffractive layer” image) width was selected as wₗ≈106.67λ. The axial distances between the encoded object and the occlusion 32, between the occlusion and the diffractive layer 18, and the diffractive layer 18 and the output FOV were ˜13.33λ, ˜106.67λ, and ˜40λ, respectively. In FIG. 28D, the input objects/messages, the simulated lens images, and the simulated and experimental diffractive decoder output images are shown for ten different handwritten digits randomly chosen from the test dataset. The experimental results reveal that the CNN-based phase encoding followed by diffractive decoding resulted in successful communication of the intended objects/messages around the opaque occlusion 32 (see the bottom row of FIG. 28D).

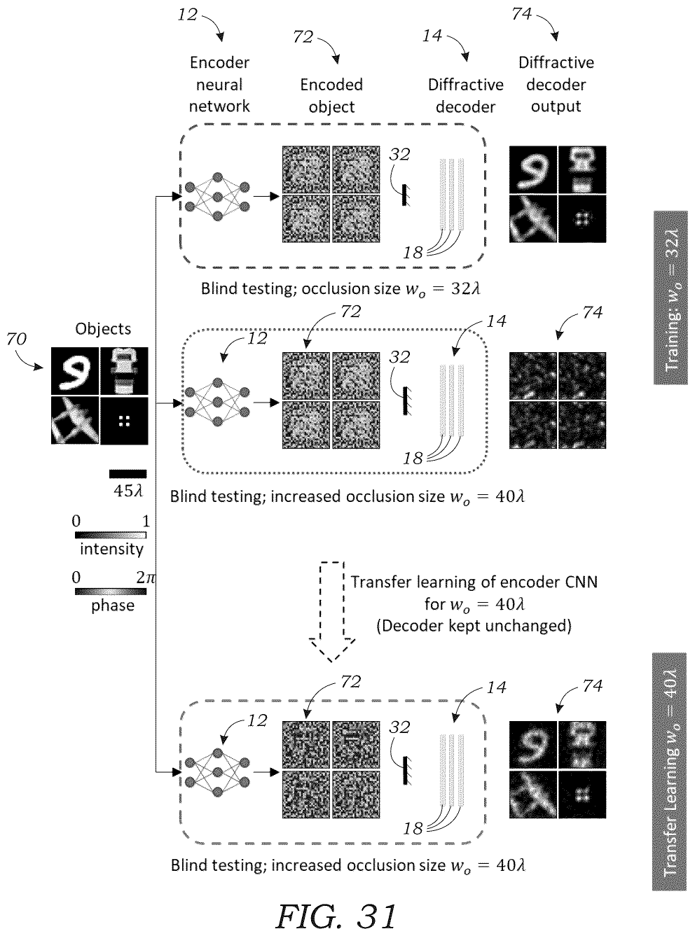

The optical communication system 30 using CNN-based encoding and diffractive all-optical decoding would be useful for the optical communication of information around opaque occlusions 32 caused by existing or evolving structures. In case such occlusions 32 change moderately over time (for example grow in size as a function of time), the same all-optical decoder network 14 that is deployed as part of the communication link can still be used with only an update of the electronic encoder network 12. To showcase this, in FIG. 31 an encoder-decoder design is illustrated with L=3 that was originally trained with an occlusion size of wₒ=32.0λ, successfully communicating the input messages between the CNN-based phase transmitter aperture and the output FOV of the all-optical decoder network 14 when the occlusion size remains the same, i.e., wₒ=32.0λ (top). FIG. 31 also illustrates the failure of this encoder-decode pair once the size of the opaque occlusion grows to wₒ=40.0λ (middle); this failure due to the (unexpectedly) increased occlusion size can be repaired without changing the deployed diffractive decoder layers by just retraining the CNN encoder part; see FIG. 31, (bottom). Here, the all-optical decoder network 14 remains unchanged but the electronic encoder network 12 undergoes transfer learning for wₒ=40.0λ.

The speed of optical communication through the encoder-decoder pair would be limited by the rate at which the encoded phase patterns (CNN outputs) can be refreshed or by the speed of the output detector-array, whichever is smaller. The transmission and the decoding processes of the desired optical information/message occur at the speed of light propagation through thin substrate layers 18 (i.e., diffractive layers) and do not consume any external power (except for the illumination light). Therefore, the main power consuming steps in the architecture are the CNN inference, the transmitter of the encoded phase patterns and the detector-array operation.

The communication around occlusions 32 using the system 30 works even when the occlusion width is larger than the width of the transmitter aperture since it utilizes CNN-based phase encoding of information to effectively exploit the scattering from the edges of the occlusions. Surprisingly, as the occlusion width surpasses the transmitter aperture width (wₜ), the performance of L=1 and L=3 designs slightly improved, as was seen in FIGS. 22A-22B. This relative improvement might be explained by a switch in the mode of operation of the encoder-decoder pair. When the opaque occlusions are smaller than the transmitter aperture, the pixels at the edges of the transmitter can communicate directly to the receiver aperture and therefore, they dominate the power balance. In this operation regime, as the occlusion size gets larger, the effective number of pixels at the transmitter aperture that directly communicates with the receiver/decoder gets smaller, causing a decline in the performance of the diffractive decoder. However, when the occlusion becomes larger than the transmitter aperture, none of the input pixels can dominate the power balance at the receiver end by communicating with it directly: instead, all the pixels of the encoder plane are forced to indirectly contribute to the receiver aperture through the edge scattering of the occlusion. This causes the performance to get better for occlusions larger than the transmitter aperture since effectively more pixels of the encoder plane can contribute to the receiver aperture without a major power imbalance among these secondary wave-based contributions (through edge scattering). This turnaround in performance (i.e., the switching behavior between these two modes of operation) is not observed when the diffractive decoder has a deeper architecture (e.g., L=5) since deeper decoders can effectively balance the ballistic photons that are transmitted from the edge pixels: consequently, edge-pixels of the transmitter aperture do not dominate the output signals even when they can directly ‘see’ the receiver aperture since multiple substrate layers 18 of a deeper all-optical decoder network 14 act as a universal mode processor.

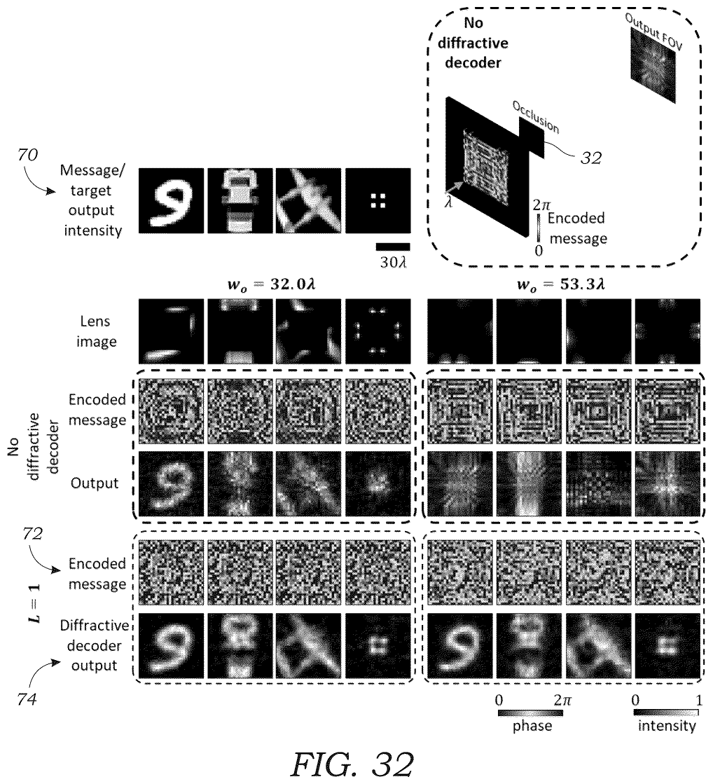

Finally, the success of the simpler all-optical decoder network 14 designs with L=1 layer, as shown in FIGS. 21-24, 28A-28D, begs the question of whether such an optical communication around opaque occlusions is also feasible with electronic encoding only, i.e., without diffractive decoding. To address this question, two encoder-only designs were trained for wₒ=32.0λ and wₒ=53.3λ and their performance was compared against L=1 designs in FIG. 32. The encoder-only architecture barely succeeds for wₒ=32.0λ and fails drastically for wₒ=53.3λ, whereas L=1 designs provide significantly better performance. This demonstrates the importance of complementing electronic encoding with diffractive decoding for effective communication around opaque occlusions.

The communication system 30 may operate at a number of wavelengths. For example, the message or signal 70 that is encoded/decoded may be transmitted at one of the following wavelengths: ultra-violet wavelengths, visible wavelengths, infrared wavelengths, THz wavelengths or millimeter wavelengths.

### Materials and Methods—Optical Communication Round Opaque Occlusions

### Model

In the model used, the message/object m that is to be transmitted is fed to a CNN-based electronic encoder network 12, which yields a phase-encoded representation ψ of the message. The message is assumed to be in the form of an Nᵢₙ×Nᵢₙ=28×28 pixel image. The coded phase ψ is assumed to have dimension Nₒᵤₜ×Nₒᵤₜ=28×28. The Nₒᵤₜ×Nₒᵤₜ phase elements are distributed over the transmitter aperture of area wₜ×wₜ, where wₜ≈59.73λ and λ is the illumination wavelength. The lateral width of each phase element/pixel is therefore wₜ/Nₒᵤₜ≈2.12λ. The phase-encoded input wave exp(jψ) propagates a distance dₜₒ≈13.33λ to the plane of the opaque occlusion, where its amplitude is modulated by the occlusion function o(x,y) such that:

$$o ( x , y ) = \{ \begin{matrix}0 , & \vert x \vert < \frac{{w}_{o}}{2} , \vert y \vert < \frac{{w}_{o}}{2} \\ 1 , & otherwise\end{matrix}$$

The encoded wave, after being obstructed and scattered by the occlusion 32, travels to the receiver through free space. At the receiver, the all-optical decoder network 14 all-optically processes and decodes the incoming wave to produce an all-optical reconstruction \hat{m}′ of the original message m at its output FOV. It is assumed that the receiver aperture, which coincides with the first layer of the diffractive decoder, is located at an axial distance of dₒᵢ≈106.67λ away from the plane of the occlusion. The effective size of the independent diffractive features of each transmissive layer (substrate layer 18) is assumed to be 0.53λ×0.53λ, and each of the L layers includes 200×200 such diffractive features 20, resulting in a lateral width of wₗ≈106.67λ for the diffractive layers 20. The layer-to-layer separation is assumed to be dₗₗ=40λ. The output FOV of the diffractive decoder 14 is assumed to be 40λ away from the last diffractive layer 18 and extend over an area w_{d}×w_{d}, where w_{d}≈59.73λ.

The diffractive decoding at the receiver involves consecutive modulation of the received wave by the L diffractive layers 18, each followed by propagation through the free space. The modulation of the incident optical wave on a diffractive layer 18 is assumed to be realized passively by its height variations. The complex transmittance \tilde{t}(x,y) of a passive diffractive layer is related to its height h(x,y) according to:

$$\tilde{t} = exp ( j \frac{2 π}{λ} ( n + jk - 1 ) h ) = exp ( - \frac{2 π k}{λ} h ) exp ( j \frac{2 π}{λ} ( n - 1 ) h ) = a exp ( j φ )$$

where n and k are the refractive index and the extinction coefficient, respectively, of the diffractive layer material at λ;

$$a = exp ( - \frac{2 π k}{λ} h ) and φ = \frac{2 π}{λ} ( n - 1 ) h$$

are the amplitude and the phase of the complex field transmittance, respectively. For the numerical simulations, it is assumed that the diffractive layers 18 are lossless, i.e., k=0, a=1, unless stated otherwise.

The propagation of the optical fields through free space is modeled using the angular spectrum method, according to which the transformation of an optical field u(x,y) after propagation by an axial distance d can be computed as follows:

$$u ( x , y ; z = {z}_{0} + d ) = {ℱ}^{- 1} \{ ℱ \{ u ( x , y ; z = {z}_{0} ) \} \times H ( {f}_{x} , {f}_{y} ; d ) \}$$

where [symbol] ( [symbol] ) is the two-dimensional Fourier (Inverse Fourier) transform operator and H(ƒₓ, ƒ_{y}; d) is the free-space transfer function for propagation by an axial distance d defined as follows:

$$H ( {f}_{x} , {f}_{y} ; d ) = \{ \begin{matrix}exp ( j \frac{2 π}{λ} d \sqrt{1 - {( λ {f}_{x} )}^{2} - {( λ {f}_{y} )}^{2}} ) , & {f}_{x}^{2} + {f}_{y}^{2} < 1 / {λ}^{2} \\ 0 , & otherwise\end{matrix}$$

In the numerical analyses, the optical fields were sampled at an interval of δ≈0.53λ along both x and y directions and the Fourier (Inverse Fourier) transforms were implemented using the Fast Fourier Transform (FFT) algorithm. For the lens-based imaging simulations reported herein, the plane wave illumination was assumed to be amplitude modulated by the object placed at the transmitter aperture, and the (thin) lens is assumed to be placed at the same plane as the plane of the first diffractive layer 18 in the encoding-decoding scheme, with the diameter of the lens aperture equal to the width of the diffractive layer, i.e., wₗ≈106.67λ.

### Training

The all-optical decoder network 14 features were parameterized using the latent variables hₗₐₜₑₙₜ such that the feature heights h are related to hₗₐₜₑₙₜ according

$$h = {h}_{max} \times \frac{1 + sin ( {h}_{latent} )}{2} ,$$

where hₘₐₓ is a hyperparameter denoting the maximum height variation.

$${h}_{max} = \frac{λ}{n - 1}$$

was used so that the corresponding maximum phase modulation was

$${φ}_{max} = 2 π .$$

The parameters of the encoder CNN 12 and the diffractive decoder 14 phase features were optimized by minimizing the loss function:

$$ℒ = {ℒ}_{pixel} + {ηℒ}_{DE} \qquad ( 1 )$$

where [symbol] ₚᵢₓₑₗ is the mean squared error (MSE) between the pixels of the desired message m and the pixels of the (scaled) decoded optical intensity \hat{m}=σ\hat{m}′, i.e.,

$${ℒ}_{pixel} = \frac{1}{{N}_{in} \times {N}_{in}} {\sum }_{j = 1}^{{N}_{in}} + {\sum }_{i = 1}^{{N}_{in}} {( {m}_{ij} {\hat{m}}_{ij}^{′} )}^{2}$$

The scaling factor σ is defined as:

$$σ = \frac{{\sum }_{j = 1}^{{N}_{in}} + {\sum }_{i = 1}^{{N}_{in}} {m}_{ij} {\hat{m}}_{ij}^{′}}{{\sum }_{j = 1}^{{N}_{in}} + {\sum }_{i = 1}^{{N}_{in}} {( {\hat{m}}_{ij}^{′} )}^{2}}$$

The additive loss term [symbol] _{DE}=1−DE, scaled by the weight η, is used to penalize against low diffraction efficiency models. DE is the diffraction efficiency, calculated as:

$$DE = \frac{1}{{N}_{in} \times {N}_{in}} {\sum }_{j = 1}^{{N}_{in}} {\sum }_{i = 1}^{{N}_{in}} {\hat{m}}_{ij}^{′}$$

The training data comprised 110,000 examples: 55,000 images from the MNIST training set and 55,000 custom-prepared images; see FIG. 29 for examples. The remaining 5,000 images of the 60,000 MNIST training images, together with 5,000 additional custom-prepared images, i.e., a total of 10,000 images, were used for validation. After the completion of each epoch, the average loss over the validation images was computed, and the model state corresponding to the smallest validation loss was selected as the ultimate design.

The electronic encoder-diffractive decoder digital models were implemented in TensorFlow version 2.4 using the Python programming language and trained on a machine with Intel® Core™ i7-8700 CPU @ 3.20 GHz and NVIDIA Geforce GTX 1080 Ti GPU. The loss function was minimized using the Adam optimizer for 50 epochs with a batch size of 4. The learning rate was initially 1e-3 and it decreased by a factor of 0.99 every 10,000 optimization steps. For the other parameters of the Adam optimizer, the default TensorFlow settings were used. The training time varied with the model size: for example, training a model with an L=3 diffractive decoder took ˜8 hours.

The native TensorFlow implementations of PSNR and SSIM were used for computing these image comparison metrics between the message m and the scaled diffractive decoder output \hat{m}.

### Experimental Design

In the experiments, the wavelength of operation was λ=0.75 mm. A single substrate layer 18 was used in the all-optical decoder network 14, i.e., L=1, with N=200² independent features 20 and the width of each feature was ˜0.53λ≈0.40 mm, resulting in an ˜80 mm×80 mm diffractive layer. The width of the transmitter aperture accommodating the encoded phase messages was wₜ≈59.73λ≈44.8 mm, same as the width of the output FOV w_{d}. The occlusion width was wₒ≈32λ≈24 mm. The distance from the transmitter aperture to the occlusion plane was dₜₒ≈13.33λ≈10 mm, while the diffractive layer 18 was dₒₗ≈106.67λ≈80 mm away from the occlusion plane. The output FOV was 40λ≈30 mm away from the diffractive layer 18.

The diffractive layers 18 and the phase-encoded messages (CNN outputs) were fabricated using a 3D printer (Objet30 Pro, Stratasys Ltd). Similar to the implementation of the diffractive layer phase, the phase-encoded messages were implemented by height variations according to

$${h}_{o} = ψ \frac{λ}{2 π ( n - 1 )} .$$

The height variations were applied on top of a uniform base thickness of 0.2 mm, used for mechanical support. The occlusion was realized by pasting aluminum on a 3D-printed substrate (see FIG. 9). The measured complex refractive index n+jk of the 3D-printing material at λ=0.75 mm was 1.6518+j0.0612.

While training the experimental model, the weight η of the diffraction efficiency-related loss term was set to be zero. To make the experimental design robust against misalignments, random lateral and axial misalignments of the encoded objects, the occlusion 32 and the diffractive layer 18 were incorporated into the optical forward model during its training. The random misalignments were modeled using the uniformly distributed random variables Δₓ˜Uniform (−λ, λ), Δ_{y}˜Uniform(−λ, λ) and Δ_{z}˜Uniform (−2λ, 2λ) representing the displacements of the encoded objects, the occlusion and the diffractive layer along x, y and z directions, respectively, from their nominal positions.

### Terahertz Experimental Setup

A WR2.2 modular amplifier/multiplier chain (AMC) 50 in conjunction with a compatible diagonal horn antenna from Virginia Diodes Inc. was used to generate a continuous-wave (CW) radiation at 0.4 THz, by multiplying a 10 dBm RF input signal via RF synthesizer 52 at ƒ_{RF1}=11.1111 GHz 36 times. To resolve low-noise output data through lock-in detection at lock-in amplifier 54, the AMC output was modulated via signal generator 56 at a rate of ƒ_{MOD}=1 kHz. The exit aperture of the horn antenna 58 was positioned ˜60 cm away from the input (encoded object) plane of the 3D-printed all-optical decoder network 14 for the incident THz wavefront to be approximately planar. A single-pixel Mixer/AMC 60, also from Virginia Diodes Inc., was used to detect the diffracted THz radiation at the output plane. To down-convert the detected signal to 1 GHZ, a 10 dBm local oscillator signal at ƒ_{RF1}=11.0833 GHz was fed via RF synthesizer 62 to the detector. The detector was placed on an X-Y positioning stage consisting of two linear motorized stages from Thorlabs NRT100, and the output FOV was scanned using a 0.5×0.1 mm detector with a scanning interval of 2 mm. The down-converted signal was amplified, using cascaded low-noise amplifiers 64 from Mini-Circuits ZRL-1150-LN+, by 40 dB and passed through a 1 GHZ (+/−10 MHZ) bandpass filter 66 (KL Electronics 3C40-1000/T10-O/O) to filter out the noise from unwanted frequency bands. The filtered signal was attenuated by a tunable attenuator (HP 8495B) 68 for linear calibration and then detected by a low-noise power detector 70 (Mini-Circuits ZX47-60). The output voltage signal was read out using a lock-in amplifier (Stanford Research SR830), where the ƒ_{MOD}=1 kHz modulation signal served as the reference signal. The lock-in amplifier readings were converted to a linear scale according to the calibration results. To enhance the signal-to-noise ratio (SNR), a 2×2 binning was applied to the THz measurements. The contrast of the measurements was digitally enhanced by saturating the top 1% and the bottom 1% of the pixel values using the built-in MATLAB function imadjust and mapping the resulting image to a dynamic range between 0 and 1.

While embodiments of the present invention have been shown and described, various modifications may be made without departing from the scope of the present invention. For example, while the all-optical decoder network 14 has been illustrated in transmission mode (where light passes through the substrate layer(s) 18) it should be appreciated that the all-optical decoder network 14 may include one or more substrate layers 18 that reflect light as explained herein. Embodiments are contemplated that utilize both transmission and reflection within the all-optical decoder network 14. In addition, in some embodiments, multiple electronic encoder networks 12 may be used to generate the low-resolution modulation patterns or images 104. Thus, the system 10 may include one or more electronic encoder networks 12. The invention, therefore, should not be limited, except to the following claims, and their equivalents.

1. A system for the display or projection of high-resolution images comprising:
at least one electronic encoder network comprising a trained deep neural network configured to receive one or more high-resolution images and generating low-resolution modulation patterns or images representative of the one or more high-resolution images using one of: a display, a projector, a screen, a spatial light modulator (SLM), or a wavefront modulator; and
an all-optical decoder network comprising one or more optically transmissive and/or reflective substrate layers arranged in an optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive light resulting from the low resolution modulation patterns or images representative of the one or more high-resolution images and optically generate corresponding high-resolution image projections at an output field-of-view.

2. The system of claim 1, wherein the low-resolution modulation patterns or images comprise phase-only modulation, amplitude-only modulation, or complex-valued modulation.

3. The system of claim 1, wherein the trained deep neural network comprises a trained convolutional neural network (CNN).

4. The system of claim 1, wherein the trained deep neural network and the plurality of physical features formed on or within the one or more optically transmissive and/or reflective substrate layers are jointly trained.

5. The system of claim 1, wherein the all-optical decoder network comprises a single optically transmissive substrate layer or a single reflective substrate layer.

6. The system of claim 1, wherein the low-resolution modulation patterns or images comprise one of the following wavelengths: ultra-violet wavelengths, visible wavelengths, infrared wavelengths, or THz wavelengths.

7. The system of claim 1, wherein the generated high-resolution image projections at the output field-of-view exhibit color information of the corresponding images.

8. The system of claim 1, wherein the generated high-resolution image projections at the output field-of-view comprise a movie.

9. The system of claim 1, wherein one or more detectors, an observation plane, a surface, or an eye are located at the output field-of-view.

10. The system of claim 1, wherein the all-optical decoder network is integrated into a wearable device, goggles, or glasses.

11. A device for decoding high-resolution images from low-resolution modulation patterns or images representative of the one or more high-resolution images comprising:
an all-optical decoder network comprising one or more optically transmissive and/or reflective substrate layers arranged in an optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive the low resolution modulation patterns or images representative of the one or more high-resolution images and optically generate corresponding high-resolution image projections at an output field-of-view.

12. The device of claim 11, wherein the all-optical decoder network is integrated into a wearable device, goggles, or glasses.

13. A method of projecting high-resolution images over a field-of-view comprising:
providing a device comprising:
at least one electronic encoder network comprising a trained deep neural network configured to receive one or more high-resolution images and generate low-resolution modulation patterns or images representative of the one or more high-resolution images using one or more of: a display, a projector, a screen, a spatial light modulator (SLM), or a wavefront modulator; and
an all-optical decoder network comprising one or more optically transmissive and/or reflective substrate layers arranged in an optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive light resulting from the low resolution modulation patterns or images representative of the one or more high-resolution images and optically generate corresponding high-resolution image projections at an output field-of-view; and
inputting one or more high-resolution images to the electronic encoder network so as to generate the low-resolution modulation patterns or images representative of the one or more high-resolution images and optically generating the corresponding high-resolution image projections at the output field-of-view.

14. The method of claim 13, wherein the low-resolution modulation patterns or images comprise phase-only modulation, amplitude-only modulation, or complex-valued modulation.

15. The method of claim 13, wherein the trained deep neural network comprises a trained convolutional neural network (CNN).

16. The method of claim 13, wherein the trained deep neural network and the plurality of physical features formed on or within the one or more optically transmissive and/or reflective substrate layers are jointly trained.

17. The method of claim 13, wherein the corresponding high-resolution image projections at the output field-of-view are projected onto an observation plane or a surface or an eye.

18. The method of claim 13, wherein the generated high-resolution image projections at the output field-of-view exhibit color information of the corresponding images.

19. The method of claim 13, wherein the generated high-resolution image projections at the output field-of-view comprise a movie.

20. A method of communicating information with one or more persons comprising:
transmitting low-resolution modulation patterns or images representative of one or more higher-resolution images containing the information using one or more of: a display, a projector, a screen, a spatial light modulator (SLM), or a wavefront modulator; and
all-optically decoding the low-resolution modulation patterns or images with one or more optically transmissive and/or reflective substrate layers arranged in an optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive light resulting from the low resolution modulation patterns or images representative of the one or more high-resolution images and generate corresponding high-resolution image projections containing the information at an output field-of-view.

21. The method of claim 20, wherein the corresponding high-resolution image projections at the output field-of-view are projected onto an observation plane, a surface, or an eye.

22. The method of claim 20, wherein the corresponding high-resolution image projections at the output field-of-view exhibit color information.

23. The method of claim 20, wherein the corresponding high-resolution image projections at the output field-of-view comprise a movie.

24. The method of claim 20, wherein the one or more optically transmissive and/or reflective substrate layers is/are integrated into a wearable device, goggles, or glasses.

25. A communication system for transmitting a message or signal in space comprising:
at least one electronic encoder network comprising a trained deep neural network configured to receive a message or signal and generate a phase-encoded and/or amplitude-encoded optical representation of the message or signal that is transmitted along an optical path; and
an all-optical decoder network comprising one or more optically transmissive and/or reflective substrate layers arranged in the optical path with the encoder network that at least partially occluded and/or blocked with an opaque occlusion and/or a diffusive medium, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive secondary optical waves scattered by the opaque occlusion and/or diffusive medium and optically generate the message or signal at an output field-of-view.

26. The communication system of claim 25, wherein the phase-encoded and/or amplitude-encoded optical representation of the message or signal is transmitted at one of the following wavelengths: ultra-violet wavelengths, visible wavelengths, infrared wavelengths, THz wavelengths or millimeter wavelengths.

27. A device for decoding an encoded optical message or signal comprising:
an all-optical decoder network comprising one or more optically transmissive and/or reflective substrate layers arranged in an optical path of the encoded optical message or signal that at least partially occluded and/or blocked with an opaque occlusion and/or a diffusive medium, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive secondary optical waves scattered by the opaque occlusion and/or diffusive medium and optically generate the message or signal at an output field-of-view.

28. The device of claim 27, wherein the all-optical decoder network is integrated into a wearable device, goggles, or glasses.

29. A method of transmitting a message or signal over space in the presence of an obstructing opaque occlusion and/or a diffusive medium comprising:
providing a system comprising:
at least one electronic encoder network comprising a trained deep neural network configured to receive a message or signal and generate a phase-encoded and/or amplitude-encoded optical representation of the message or signal that is transmitted along an optical path; and
an all-optical decoder network comprising one or more optically transmissive and/or reflective substrate layers arranged in the optical path, each of the optically transmissive and/or reflective substrate layer(s) comprising a plurality of physical features formed on or within the one or more optically transmissive and/or reflective substrate layers and having different transmission and/or reflective properties as a function of local coordinates across each substrate layer, wherein the one or more optically transmissive and/or reflective substrate layers and the plurality of physical features receive secondary optical waves scattered by the opaque occlusion and/or diffusive medium and optically generate the message or signal at an output field-of-view; and
inputting one or more messages or signal to the electronic encoder network so as to generate the phase-encoded and/or amplitude-encoded optical representation of the message or signal and optically generating the message or signal at the output field-of-view.

30. The method of claim 29, wherein the at least one electronic encoder network and the all-optical decoder network are jointly trained and optimized.
